(19) United States
(12) Patent Application Publication
(10) Pub. No.: US 2022/0278356 A1
(43) Pub. Date: Sep. 1, 2022

(54) INORGANIC SOLID ELECTROLYTE-CONTAINING COMPOSITION, SHEET FOR ALL-SOLID STATE SECONDARY BATTERY, AND ALL-SOLID STATE SECONDARY BATTERY, AND MANUFACTURING METHODS FOR SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Yusuke IIZUKA, Kanagawa (JP); Koji YASUDA, Kanagawa (JP); Tetsuya MATSUSHITA, Kanagawa (JP); Hiroaki MOCHIZUKI, Kanagawa (JP)

(73) Assignee: FUJIFILM Corporation, Tokyo (JP)

(21) Appl. No.: 17/730,198

(22) Filed: Apr. 27, 2022

Related U.S. Application Data
(63) Continuation of application No. PCT/JP2020/040680, filed on Oct. 29, 2020.

(30) Foreign Application Priority Data
Oct. 30, 2019 (JP) 2019-197783

(51) Int. Cl. H01M 10/056

(52) U.S. Cl. CPC H01M 10/056; H01M 2300/0068; H01M 2300/0091; H01M 2300/0082

(57) ABSTRACT

There is provided an inorganic solid electrolyte-containing composition containing an inorganic solid electrolyte, binder particles having an average particle diameter of 10 to 1,000 nm, and a dispersion medium, in which a block polymer is contained to constitute the binder particles, this block polymer contains a block polymerized chain which has a terminal block chain having a C Log P value of 2 or more and having a specific constitutional component and has a block chain having a C Log P value of 1 or less, the block chain being adjacent to this terminal block chain. There are also provided a sheet for an all-solid state secondary battery and an all-solid state secondary battery, and manufacturing methods for a sheet for an all-solid state secondary battery and an all-solid state secondary battery.

### CROSS-REFERENCE TO RELATED APPLICATIONS

This application is a Continuation of PCT International Application No. PCT/JP2020/040680 filed on Oct. 29, 2020, which claims priority under 35 U.S.C. § 119 (a) to Japanese Patent Application No. JP2019-197783 filed in Japan on Oct. 30, 2019. Each of the above applications is hereby expressly incorporated by reference, in its entirety, into the present application.

### BACKGROUND OF THE INVENTION

### 1. Field of the Invention

The present invention relates to an inorganic solid electrolyte-containing composition, a sheet for an all-solid state secondary battery, and an all-solid state secondary battery, and manufacturing methods for a sheet for an all-solid state secondary battery and an all-solid state secondary battery.

### 2. Description of the Background Art

In an all-solid state secondary battery, all of a negative electrode, an electrolyte, and a positive electrode consist of solid, and the all-solid state secondary battery can improve safety and reliability, which are said to be problems to be solved in a battery in which an organic electrolytic solution is used. It is also said to be capable of extending the battery life. Furthermore, all-solid state secondary batteries can be provided with a structure in which the electrodes and the electrolyte are directly disposed in series. As a result, it becomes possible to increase the energy density to be high as compared with a secondary battery in which an organic electrolytic solution is used, and thus the application to electric vehicles, large-sized storage batteries, and the like is anticipated.

In such an all-solid state secondary battery, various technologies in which any layer of the constitutional layers (an inorganic solid electrolyte layer, a negative electrode active material layer, and a positive electrode active material layer, and the like) is formed of a material (a constitutional layer forming material) containing an inorganic solid electrolyte or an active material and containing a binder (a binding agent) consisting of a block polymer have been proposed. For example, WO2017/030154A discloses a solid electrolyte composition containing a block polymer and an inorganic solid electrolyte having an ion conductivity of a metal belonging to Group 1 or Group 2 of the periodic table, where the block polymer contains at least one kind of block chain consisting of a repeating unit having at least one specific functional group. In addition, 2011-054439A discloses a solid electrolyte slurry containing a block polymer constituted of a segment A having a ratio of 0 or more and less than 0.3 and a segment B having a ratio of 0.35 or more and less than 10, the ratio being a ratio of organicity to inorganicity based on the organic conceptual diagram, and containing a solid electrolyte material and a solvent. Further, WO2011/037254A discloses a slurry which contains a binder for a secondary battery electrode, the binder containing a block chain copolymer which does not contain a halogen atom and does not contain an unsaturated bond in the main chain, and contains an electrode active substance. 2012-204303A discloses a slurry which contains a binder for a secondary battery electrode, the binder containing a block chain copolymer which has a segment A containing a structural unit of a vinyl monomer having an acid component and has a segment B containing a structural unit of a (meth)acrylic acid alkyl ester monomer, and contains an electrode active material.

### SUMMARY OF THE INVENTION

In a constitutional layer of an all-solid state secondary battery, formed of solid particle materials (an inorganic solid electrolyte, an active material, a conductive auxiliary agent, and the like), in general, the interfacial contact state (the binding state) between solid particle materials (also simply referred to as solid particles) is not sufficiently formed. In a case where this is not sufficient formed, the interfacial resistance between solid particles increase, which resultantly leads to the increase in the electric resistance of the all-solid state secondary battery.

The interfacial contact state between solid particles can be improved by using a binder in combination with the solid particles. By the way, in recent years, research and development for improving the performance and the practical application of electric vehicles have progressed rapidly, and the demand for battery performance required for all-solid state secondary batteries has become higher. The binders described in 2011-054439A, WO2011/037254A, and 2012-204303A cannot meet such demands of recent years. For example, the binder described in WO2017/030154A is said to be able to improve the dispersion stability of solid particles; however, there is room for further improvement in order to fully meet the demands of recent years.

An object of the present invention is to provide an inorganic solid electrolyte-containing composition capable of enhancing the dispersion stability of solid particles with respect to a dispersion medium and realizing a constitutional layer in which an increase in interfacial resistance between solid particles is suppressed. In addition, another object of the present invention is to provide a sheet for an all-solid state secondary battery and an all-solid state secondary battery, and manufacturing methods for a sheet for an all-solid state secondary battery and an all-solid state secondary battery, in which the above inorganic solid electrolyte-containing composition is used.

As a result of various studies, the inventors of the present invention have found that in a case where a binder that is used in combination with solid particles such as an inorganic solid electrolyte, in an inorganic solid electrolyte-containing composition, is formed into a particulate shape having a specific size by using a block polymer obtained by introducing a block chain having a C Log P value of 2 or more and having a specific constitutional component as a terminal block chain, and introducing a block chain having a C Log P value of 1 or less as a block chain adjacent to this terminal block chain, the dispersion stability of the inorganic solid electrolyte can be further enhanced and the increase in the interfacial resistance between solid particles in the constitutional layer can be suppressed. The present invention has been completed through further studies based on these findings.

That is, the above problems have been solved by the following means.

<1> An inorganic solid electrolyte-containing composition comprising an inorganic solid electrolyte having an ion conductivity of a metal belonging to Group 1 or Group 2 in the periodic table; binder particles having an average particle diameter of 10 nm or more and 1,000 nm or less; and a dispersion medium,

in which a block polymer is contained to constitute the binder particles, and

the block polymer contains a block polymerized chain which has at least one terminal block chain having a C Log P value of 2 or more and having a constitutional component represented by Formula (1) and has a block chain having a C Log P value of 1 or less, the block chain being adjacent to the terminal block chain,

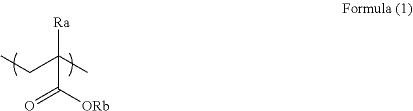

in Formula (1), Ra represents a hydrogen atom, a hydroxy group, a cyano group, a halogen atom, or an alkyl group having 1 to 6 carbon atoms, and Rb represents a linear or branched alkyl group having 3 or more carbon atoms.

<2> The inorganic solid electrolyte-containing composition according to <1>, in which the terminal block chain contains at least two constitutional components.

<3> The inorganic solid electrolyte-containing composition according to <1> or <2>, in which the block polymer is represented by Formula (2),

A-B Formula (2)

in Formula (2), A represents the terminal block chain, and B represents the block chain having a C Log P value of 1 or less.

<4> The inorganic solid electrolyte-containing composition according to <1> or <2>, in which the block polymer is represented by Formula (3),

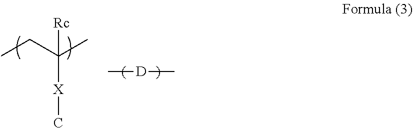

in Formula (3), Re represents a hydrogen atom, a hydroxy group, a cyano group, a halogen atom, or an alkyl group having 1 to 6 carbon atoms, and X represents a divalent linking group, C represents the block polymerized chain, and D represents a constitutional component having a C Log P value of 1 or less.

<5> The inorganic solid electrolyte-containing composition according to <4>, in which X is an alkylene group having 1 to 6 carbon atoms, an oxygen atom, a cyano group, a carbonyl group, or a group obtained by combining these, and is a linking group having 1 to 35 constituent atoms.

<6> The inorganic solid electrolyte-containing composition according to <3>, in which in the block polymerized chain, a content of the terminal block chain is 35% by mole or less, and a content of the block chain having a C Log P value of 1 or less is 65% by mole or more.

<7> The inorganic solid electrolyte-containing composition according to any one of <1> to <6>, in which the binder particles have an average particle diameter of 50 to 250 nm.

<8> The inorganic solid electrolyte-containing composition according to any one of <1> to <7>, in which an alkyl group adoptable as Rb has 8 or more carbon atoms.

<9> The inorganic solid electrolyte-containing composition according to any one of <1> to <8>, in which the terminal block chain has a C Log P value of 3.5 or more.

<10> The inorganic solid electrolyte-containing composition according to any one of <1> to <9>, in which a C log P value of the block chain having a C log P value of 1 or less is 0.7 or less.

<11> The inorganic solid electrolyte-containing composition according to any one of <1> to <10>, in which the block chain having a C Log P value of 1 or less contains a constitutional component derived from a (meth)acrylic acid or a (meth)acrylic acid ester compound.

<12> The inorganic solid electrolyte-containing composition according to any one of <1> to <11>, in which the block chain having a C Log P value of 1 or less has a functional group selected from the following group G of functional groups,

<The Group G of Functional Groups>

a hydroxy group, a mercapto group, a carboxy group, a phosphate group, an amino group, a cyano group, an isocyanate group, an amide group, a urea group, a urethane group, an imide group, an isocyanurate group.

<13> The inorganic solid electrolyte-containing composition according to any one of <1> to <12>, further comprising an active material.

<14> The inorganic solid electrolyte-containing composition according to any one of <1> to <13>, further comprising a conductive auxiliary agent.

<15> The inorganic solid electrolyte-containing composition according to any one of <1> to <14>, in which the inorganic solid electrolyte is a sulfide-based inorganic solid electrolyte.

<16> A sheet for an all-solid state secondary battery, comprising a layer formed of the inorganic solid electrolyte-containing composition according to any one of <1> to <15>.

<17> An all-solid state secondary battery comprising, in the following order, a positive electrode active material layer; a solid electrolyte layer; and a negative electrode active material layer,

in which at least one of the positive electrode active material layer, the solid electrolyte layer, or the negative electrode active material layer is a layer formed of the inorganic solid electrolyte-containing composition according to any one of <1> to <15>.

<18> A manufacturing method for a sheet for an all-solid state secondary battery, the manufacturing method comprising forming a film of the inorganic solid electrolyte-containing composition according to any one of <1> to <15>.

<19> A manufacturing method for an all-solid state secondary battery, comprising manufacturing an all-solid state secondary battery through the manufacturing method according to <18>.

According to the present invention, it is possible to provide an inorganic solid electrolyte-containing composition having excellent dispersion stability and capable of realizing a constitutional layer in which an increase in interfacial resistance between solid particles is suppressed. In addition, according to the present invention, it is possible to provide a sheet for an all-solid state secondary battery and an all-solid state secondary battery, which have a layer constituted of the above inorganic solid electrolyte-containing composition. Further, according to the present invention, it is possible to provide manufacturing methods for a sheet for an all-solid state secondary battery and an all-solid state secondary battery, in which the above inorganic solid electrolyte-containing composition is used.

The above-described and other characteristics and advantages of the present invention will be further clarified by the following description with appropriate reference to the accompanying drawing.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating a coin-type all-solid state secondary battery prepared in Examples.

### DESCRIPTION OF THE PREFERRED EMBODIMENTS

In the present invention, numerical ranges indicated using “to” include numerical values before and after the “to” as the lower limit value and the upper limit value.

In the present invention, the expression of a compound (for example, in a case where a compound is represented by an expression in which “compound” is attached to the end) is used as the meaning of not only the compound itself but also a salt or an ion thereof. In addition, this expression also has the meaning of a derivative obtained by modifying a part of the compound, for example, by introducing a substituent into the compound within a range where the effects of the present invention are not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same shall be applied to a compound that is not specified in the present specification regarding whether to be substituted or unsubstituted. Examples of the preferred examples of the substituent include a substituent Z described below.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer; however, it is synonymous with a so-called polymeric compound. Further, a polymer binder (also simply referred to as a binder) means a binder constituted of a polymer and includes a polymer itself and a binder formed by containing a polymer.

[Inorganic Solid Electrolyte-Containing Composition]

The inorganic solid electrolyte-containing composition according to the embodiment of the present invention contains an inorganic solid electrolyte having an ion conductivity of a metal belonging to Group 1 or Group 2 in the periodic table; binder particles having an average particle diameter of 10 nm or more and 1,000 nm or less; and a dispersion medium. The binder particles contained in this inorganic solid electrolyte-containing composition is constituted to have a particulate shape having a size in the above arrange by containing a block polymer containing a block polymerized chain which has at least one terminal block chain having a C Log P value of 2 or more and having a constitutional component represented by Formula (1) and has a block chain having a C Log P value of 1 or less, the block chain being adjacent to the terminal block chain.

In the inorganic solid electrolyte-containing composition, the binder particles have a function of dispersing solid particles in the dispersion medium and are conceived to contribute to the improvement of the dispersion stability of the solid particles. These binder particles are preferably dispersed (in a solid state) in the inorganic solid electrolyte-containing composition (the dispersion medium); however, a part thereof may be dissolved in the dispersion medium as long as the effects of the present invention is not impaired. The inorganic solid electrolyte-containing composition according to the embodiment of the present invention is preferably a slurry in which the inorganic solid electrolyte is dispersed in a dispersion medium.

The binder particles contained in the inorganic solid electrolyte-containing composition according to the embodiment of the present invention functions, in a layer formed of at least an inorganic solid electrolyte-containing composition, as a binding agent that binds solid particles of an inorganic solid electrolyte (as well as a co-existable active material, conductive auxiliary agent, and the like) or the like to to each other (for example, solid particles of an inorganic solid electrolyte to each other, solid particles of an inorganic solid electrolyte and an active material to each other, or solid particles of an active material to each other). Further, it may function as a binding agent that causes a collector to bind to solid particles. The binder particles contained in the inorganic solid electrolyte-containing composition according to the embodiment of the present invention may have or may not have a function of causing solid particles to bind mutually in the inorganic solid electrolyte-containing composition.

According to the inorganic solid electrolyte-containing composition according to the embodiment of the present invention, it is possible to form a constitutional layer in which an increase in interfacial resistance between solid particles is suppressed. As a result, in a case where the inorganic solid electrolyte-containing composition according to the embodiment of the present invention is used as a constitutional layer forming material, it is possible to realize a sheet for an all-solid state secondary battery, having a low-resistance constitutional layer, as well as an all-solid state secondary battery.

Although the details of the reason for the above effects are not yet clear, they are conceived to be as follows.

That is, it is presumed that in the inorganic solid electrolyte-containing composition (the dispersion medium), a block chain of a block polymer that constitutes the binder particle, the block chain having a C Log P value of 1 or less, forms a core portion (or these block chains are aggregated to form a core portion) of the binder particle, and the particle having a specific size, in which the terminal block chain extends from this core portion, is formed. For this reason, the high dispersion stability is exhibited in the dispersion medium.

It is conceived that in the inorganic solid electrolyte-containing composition, the core portion of the binder particle is partially and firmly adsorbed on the surface of the solid particle without impairing the particle shape and size of the binder particle. For this reason, in the solid particle on which the binder particle is adsorbed, dispersibility in the dispersion medium is increased due to the terminal block chain, and temporal reaggregation or sedimentation with time is suppressed (dispersion stability is improved). As a result, it is possible to suppress the variation in the contact state while maintaining the contact state (the strong binding state) between the solid particles in the constitutional layer formed of this inorganic solid electrolyte-containing composition, and it is possible to suppress an increase in the interfacial resistance between the solid particles as well as the resistance of the constitutional layer.

The inorganic solid electrolyte-containing composition according to the embodiment of the present invention can be preferably used a material (a constitutional layer forming material) for forming a solid electrolyte layer or an active material layer, where the material is for a sheet for an all-solid state secondary battery (including an electrode sheet for an all-solid state secondary battery) or an all-solid state secondary battery.

The inorganic solid electrolyte-containing composition according to the embodiment of the present invention is preferably a non-aqueous composition. In the present invention, the non-aqueous composition includes not only an aspect containing no moisture but also an aspect where the moisture content (also referred to as the “water content”) is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (the mass proportion to the inorganic solid electrolyte-containing composition) in the inorganic solid electrolyte-containing composition, and specifically, it is a value measured by filtration through a 0.02 μm membrane filter and then by the Karl Fischer titration.

The inorganic solid electrolyte-containing composition according to the embodiment of the present invention includes an aspect including not only an inorganic solid electrolyte but also an active material, as well as a conductive auxiliary agent or the like (the composition in this aspect may be referred to as the “electrode composition”).

Hereinafter, constitutional components that are contained and constitutional components that can be contained in the inorganic solid electrolyte-containing composition according to the embodiment of the present invention will be described.

<Inorganic Solid Electrolyte>

The inorganic solid electrolyte-containing composition according to the embodiment of the present invention contains an inorganic solid electrolyte.

In the present invention, the inorganic solid electrolyte is an inorganic solid electrolyte, and the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since the inorganic solid electrolyte does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has an ion conductivity of a lithium ion.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

(i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which, as elements, contain at least Li, S, and P and have a lithium ion conductivity, but the sulfide-based inorganic solid electrolytes may also include elements other than Li, S, and P depending on the purposes or cases.

Examples of the sulfide-based inorganic solid electrolyte include a lithium ion-conductive inorganic solid electrolyte satisfying the composition represented by Formula (S1).

Lₐ₁M_{b1}P_{C1}S_{d1}Aₑ₁ Formula (S1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F, and a1 to e1 represent the compositional ratios between the respective elements, and a1:b1:e1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase an ion lithium ion conductivity. Specifically, the ion conductivity of the lithium ion can be preferably set to 1×10⁻⁴ S/cm or more and more preferably set to 1×10⁻³ S/cm or more. The upper limit is not particularly limited but practically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂S₁₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This because treatments at a normal temperature become possible, and it is possible to simplify manufacturing processes.

(ii) Oxide-Based Inorganic Solid Electrolytes

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0≤xc≤5, ye satisfies 0≤ye≤1, zc satisfies 0≤zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li₍₃₋₂ₓₑ₎M^{ee}ₓₑD^{ee}O (xe represents a number between 0 and 0.1, and M^{ee} represents a divalent metal atom, D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable.

Examples thereof include lithium phosphate (Li₃PO₄); LiPON in which a part of oxygen atoms in lithium phosphate are substituted with a nitrogen atom; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

(iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte is preferably particulate. In this case, the average particle diameter (the volume average particle diameter) of the inorganic solid electrolyte is not particularly limited; however, it is preferably 0.01 μm or more and more preferably 0.1 μm or more. The upper limit is preferably 100 μm or less and more preferably 50 μm or less.

The average particle diameter of the inorganic solid electrolyte is measured in the following procedure. The inorganic solid electrolyte particles are diluted and prepared using water (heptane in a case where the inorganic solid electrolyte is a substance unstable in water) in a 20 mL sample bottle to prepare 10% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/s scattering-type particle size distribution analyzer LA-920 (product name, manufactured by Horiba Ltd.), and a quartz cell for measurement at a temperature of 25° C. to obtain the volume average particle diameter. Other detailed conditions and the like can be found in Japanese Industrial Standards (JIS) Z8828: 2013 “particle diameter Analysis-Dynamic Light Scattering” as necessary. Five samples per level are produced and measured, and the average values thereof are employed.

One kind of inorganic solid electrolyte may be contained, or two or more kinds thereof may be contained.

In a case of forming a solid electrolyte layer, the mass (mg) (mass per unit area) of the inorganic solid electrolyte per unit area (cm²) of the solid electrolyte layer is not particularly limited. It can be appropriately determined according to the designed battery capacity and can be set to, for example, 1 to 100 mg/cm².

However, in a case where the inorganic solid electrolyte-containing composition contains an active material described later, the mass per unit area of the inorganic solid electrolyte is preferably such that the total amount of the active material and the inorganic solid electrolyte is in the above range.

The content of the inorganic solid electrolyte in the inorganic solid electrolyte-containing composition is not particularly limited. However, in terms of the binding property as well as in terms of dispersibility, it is preferably 50% by mass or more, more preferably 70% by mass or more, and still more preferably 90% by mass or more, in the solid content of 100% by mass. From the same viewpoint, the upper limit thereof is preferably 99.9% by mass or less, more preferably 99.5% by mass or less, and particularly preferably 99% by mass or less.

However, in a case where the inorganic solid electrolyte-containing composition contains an active material described below, regarding the content of the inorganic solid electrolyte in the inorganic solid electrolyte-containing composition, the total content of the active material and the inorganic solid electrolyte is preferably in the above-described range.

In the present invention, the solid content (solid constitutional component) refers to constitutional components that neither volatilize nor evaporate and disappear in a case where the inorganic solid electrolyte-containing composition is subjected to drying treatment at 150° C. for 6 hours in a nitrogen atmosphere at a pressure of 1 mmHg. Typically, the solid content refers to a constitutional component other than a dispersion medium described below.

<Binder Particle>

The inorganic solid electrolyte-containing composition according to the embodiment of the present invention contains at least one kind of binder particle having an average particle diameter of 10 nm or more and 1,000 nm or less. The binder particles contained in the inorganic solid electrolyte-containing composition are not particularly limited; however, 1 to 5 kinds thereof can be contained.

In a case where the binder particles have an average particle diameter of 10 to 1,000 nm, it is possible to achieve both the dispersion stability (lower resistance) of the solid particles and the binding property between the solid particles at the same time. In terms of the binding property between the solid particles, the average particle diameter of the binder particles is preferably 30 nm or more and more preferably 50 nm or more in terms of the binding property between the solid particles. On the other hand, in terms of lower resistance, the average primary particle diameter is preferably 500 nm or less, more preferably 300 nm or less, still more preferably 250 nm or less, and particularly preferably 200 nm or less. The average particle diameter of the binder particles can be measured using the same method as that of the average particle diameter of the inorganic solid electrolyte.

The average particle diameter of the binder particles in the constitutional layer of the all-solid state secondary battery is measured, for example, by disassembling the battery to peel off the constitutional layer containing the binder particle, subsequently subjecting the constitutional layer to measurement, and excluding the measured value of the particle diameter of particles other than the binder particle, which has been measured in advance.

It is possible to adjust the average particle diameter of the binder particles with, for example, the kind of solvent that is used in the synthesis of the block polymer, the time or temperature of synthesis (polymerization reaction) as well as the kind of polymerization method, and the kind and content of the constitutional component in the block polymer.

The shape of the binder particle is not particularly limited and may be a flat shape, an amorphous shape, or the like; however, a spherical shape or a granular shape is preferable.

A block polymer is contained to constitute the binder particle. Accordingly, it suffices that the binder particle contains at least one kind of molecule of block polymer. Two or more kinds of molecules of block polymer, which may be identical to or different from each other, may be contained to constitute the binder particle, and moreover, a constitutional component other than the block polymer may be contained.

(Block Polymer)

The block polymer that constitutes (forms) the binder particles is a polymer containing a block polymerized chain having a terminal block chain and a block chain adjacent to the terminal block chain. Accordingly, the block polymer specified in the present invention is not particularly limited as long as it contains the above-described block polymerized chain, and the main chain may be or may not be the block polymerized chain. Such a block polymer includes an aspect including a block polymerized chain as a main chain (for example, the block polymer B-1 synthesized in Example), an aspect including a block polymerized chain as a side chain (for example, the block polymer B-4 synthesized in Example), and an aspect including a block polymerized chain as a main chain and as a side chain. In a case where the main chain or side chain contains a block polymerized chain, the block polymerized chain is incorporated as the whole or part of the main chain or side chain. It in noted that the respective block chain and the block polymerized chain refer to chains that do not contain the terminal group.

An appropriate group such as a hydrogen atom, a chain transfer agent residue, an initiator residue, or the like is introduced into the terminal group of the block polymer by a polymerization method, a polymerization termination method, or the like.

In the present invention, a main chain of the polymer refers to a linear molecular chain in which all the molecular chains that constitute the polymer other than the main chain can be conceived as a branched chain or a pendant with respect to the main chain. Although it depends on the mass average molecular weight of the molecular chain regarded as a branched chain or pendant chain, the longest chain among the molecular chains that constitutes the polymer is typically the main chain. In this case, the terminal group at the polymer terminal is not included in the main chain. In addition, the side chain of the polymer refer to a molecular chain other than the main chain and includes a short molecular chain and a long molecular chain.

In the aspect in which the block polymer contains a block polymerized chain as the main chain, polymers containing a block polymerized chain described later in the main chain are preferable, and among them, a polymer containing an A-B block polymerized chain structure is more preferable, and a polymer represented by Formula (2) is more preferable.

A-B Formula (2)

In Formula (2), A-B is synonymous with an A-B block polymerized chain structure (a binary block copolymerized chain in which n=1) described later, where A represents a terminal block chain described later and B represents a polar block chain described later. However, each block chain does not have a terminal group.

The contents of A and B in this block polymer are the same as the contents of the terminal block chain and the polar block chain in the block polymerized chain described later.

In the aspect in which the block polymer contains a block polymerized chain as the side chain, the block polymer is preferably a copolymer of a polymer represented by Formula (3), that is, a constitutional component having a block polymerized chain C, and a constitutional component represented by D. The block polymerized chain C contained in this block polymer is not particularly limited, and examples thereof include block polymerized chain structures described later. Among them, an A-B block polymerized chain structure (a terminal block chain A is bonded to the main chain of the block polymer blocked through the polar block chain B) is preferable. In a case where the block polymer has a plurality of constitutional components having the block polymerized chains C, the plurality of block polymerized chains C contained in each constitutional component may be the same or different from each other.

The block polymer represented by Formula (3) has a main chain consisting of a carbon-carbon bonding chain of a constitutional component having the block polymerized chain C and a constitutional component D and has the block polymerized chain C through a linking group X as a side chain thereof.

The main chain of the block polymer represented by Formula (3) may be a main chain consisting of a sequential polymerization (polycondensation, polyaddition, or addition condensation) polymer such as polyurethane, polyurea, polyamide, polyimide, or polyester. However, it is preferably a main chain consisting of a chain polymerization polymer such as a fluorine-based polymer (a fluorine-containing polymer), a hydrocarbon-based polymer, a vinyl polymer, or a (meth)acrylic polymer, and more preferably a main chain consisting of a (meth)acrylic polymer. The (meth)acrylic polymer is a polymer having 50% by mole or more of a constitutional component derived from a (meth)acrylic compound described later.

The main chain of the block polymer represented by Formula (3) may be a random copolymerized chain, block copolymerized chain, or alternate copolymerized chain of each constitutional component; however, it is preferably a random copolymerized chain.

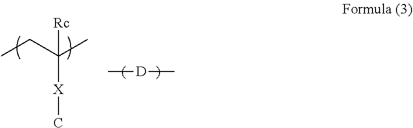

In Formula (3), Re represents a hydrogen atom, a hydroxy group, a cyano group, a halogen atom (a fluorine atom, a chlorine atom, a bromine atom, an iodine atom, or the like), or an alkyl group having 1 to 6 carbon atoms. Re is synonymous with Ra in Formula (1) described later, and the same applies to the preferred one thereof.

X represents a divalent linking group, The linking group that can be adopted as X is not particularly limited. However, examples thereof include an alkylene group having 1 to 6 carbon atoms (preferably 1 to 3 carbon atoms), an alkenylene group having 2 to 6 carbon atoms (preferably 2 or 3 carbon atoms), an arylene group having 6 to 22 carbon atoms (preferably 6 to 10 carbon atoms), an oxygen atom, a cyano group, a sulfur atom, an imino group (—NR^{N}—: R^{N} represents a hydrogen atom, an alkyl group having 1 to 6 carbon atoms, or an aryl group having 6 to 10 carbon atoms), a carbonyl group, and a phosphate linking group (—O—P(OH)(O)—O—), a phosphonate linking group (—P(OH)(O)—O—), and a group obtained by combining these. X is preferably an alkylene group having 1 to 6 carbon atoms, an oxygen atom, a cyano group, a carbonyl group, or a group obtained by combining these, more preferably a group containing a —CO—O— group or —CO—N(R^{N})— group (R^{N} is as described above), and still more preferably a group containing an alkylene group, a carbonyl group, an oxygen atom, a cyano group, or the like. In the group obtained by combination, the number of combined groups is not particularly limited, and it can be, for example, 2 to 20 and is preferably 4 to 15.

In the present invention, the number of atoms that constitute a linking group (referred to as the number of constituent atoms) is preferably 1 to 35, more preferably 5 to 32, and still more preferably 10 to 30. The number of linking atoms of the linking group is preferably 30 or less, more preferably 20 or less, and it can be also 15 or less. The lower limit thereof is 1 or more. The number of linking atoms refers to the minimum number of atoms linking predetermined structural parts. For example, in a case of —CH₂—C(═O)—O—, the number of atoms that constitutes the linking group is 6; however, the number of linking atoms is 3.

The 1,2-ethanediyl structure having the linking group X in Formula (3) is formed from, for example, a residue of the chain transfer agent or polymerization initiator used in the polymerization of the block polymerized chain C and an ethylenically unsaturated bond-containing compound having a functional group that reacts with this residue. For example, in a block polymer B-4 and the like described later, it is formed from a residue of 4-cyano-4-[(dodecylsulfanylthiocarbonyl)sulfanyl]pentanic acid (—C(CH₃)(CN)C₂H₄COOH) and glycidyl methacrylate. Examples of the ethylenically unsaturated bond-containing compound having a functional group that reacts with the above residue include an ethylenically unsaturated bond-containing compound having a functional group (preferably a (meth)acrylic compound or a vinyl compound) that exhibits the reactivity such as addition reaction, substitution reaction, or condensation reaction depending on the kind of residue (a chain transfer agent or polymerization initiator).

The above linking group may have any substituent. Examples of any substituent include a substituent Z described above, and examples thereof include an alkyl group and a halogen atom.

In Formula (3), C represents a block polymerized chain described later, and specifically, it is a block polymerized chain having at least one terminal block chain and having a polar block chain adjacent to the terminal block chain. The block polymerized chain C contained in the block polymer represented by Formula (3) is synonymous with the A-B block polymerized chain structure contained in the block polymer represented by Formula (2), and the same applies to the preferred one thereof.

Examples of the constitutional component having the block polymerized chain C include a constitutional component derived from a compound obtained by introducing the block polymerized chain C into an ethylenically unsaturated bond-containing compound.

In the block polymer represented by Formula (3), the number of block polymerized chains C in the constitutional component containing the block polymerized chains C is not particularly limited and may be one or plural.

In Formula (3), D represents a constitutional component having a C Log P value of 1 or less, and it is a constitutional component copolymerized with the constitutional component having the block polymerized chain C.

The C Log P value of this constitutional component is preferably 1 or less, more preferably 0.9 or less, and still more preferably 0.8 or less, in terms of the binding property and dispersion stability between solid particles. The lower limit thereof is not particularly limited, and it is practically −3 or more, preferably −2 or more, and more preferably −1 or more.

The C Log P value to be employed is a value of a compound (a copolymerizable compound) from which this constitutional component is derived, not a value in a state of being (not a value of a constitutional component) incorporated into the polymer. The calculation method therefor is the same as the calculation method for the terminal block chain described later.

The copolymerizable compound that derives D is not particularly limited as long as it satisfies the C Log P value; however, examples thereof include an ethylenically unsaturated bond-containing compound from which another constitutional component contained in the terminal block chain is derived (however, the alkyl group of the (meth)acrylic acid alkyl ester compound is not limited to a short-chain alkyl group, and the upper limit of the number of carbon atoms is the same as that of the alkyl group that can be adopted as Rb in Formula (1) described later). Among the above, a (meth)acrylic acid alkyl ester compound is preferable.

The copolymerizable compound may have a substituent. The substituent is not particularly limited, and examples thereof include a group selected from the substituent Z described later. Among the above, it is preferable to have a functional group selected from the group G of functional groups described later in terms of the C log P value.

Examples of such a copolymerizable compound include, in addition to the compounds used in Examples such as mono(2-acryloyloxyethyl) succinate, 2-hydroxyethyl acrylate, methacrylic acid, and dimethylacrylamide, acrylic acid, 2-hydroxyethyl methacrylate, hydroxypropyl acrylate, hydroxypropyl methacrylate, acrylonitrile, N-isopropylacrylamide, dimethylacrylamide, N-t-butylacrylamide, and a (poly)alkylene glycol (meth)acrylic acid ester compound.

The C Log P value of the copolymerizable compound that derives to D can be appropriately adjusted depending on, for example, the chemical structure of the copolymerizable compound and the presence or absence of the functional group selected from the substituent Z or the group G of functional groups.

In the block polymer represented by Formula (3), the constitutional component D may be a single constitutional component. However, it may be a plurality of constitutional components and is preferably a block polymerized chain consisting of a plurality of constitutional components.

In the block polymer represented by Formula (3), the content of the constitutional component having the block polymerized chain C is preferably 0.10% by mole or more, more preferably 0.2% by mole or more, and still more preferably 0.4% by mole or more, with respect to all the constitutional components that constitute the block polymer (generally, the total number of moles of a constitutional component having the block polymerized chain C and the above-described constitutional component D), in terms of dispersion stability. In terms of the binding property between the solid particles, the upper limit thereof is preferably 20% by mole or less, more preferably 10% by mole or less, and still more preferably 5% by mole or less.

In the block polymer represented by Formula (3), the content of the constitutional component represented by D is preferably 80% by mole or more, more preferably 90% by mole or more, and still more preferably 95% by mole or more with respect to all the constitutional components that constitute the block polymer, in terms of the binding property between the solid particles. The upper limit thereof is preferably 99.9% by mole or less, more preferably 99.8% by mole or less, and still more preferably 99.7% by mole or less, in terms of dispersion stability.

The (molar) ratio of copolymerization of the block polymerized chain C to the constitutional component (the block polymerized chain) D is preferably 1:99 to 30:70, more preferably 1:99 to 20:80, and still more preferably 1:99 to 10:90.

((Block Polymerized Chain))

The block polymerized chain has at least one terminal block chain having a C Log P value of 2 or more and having a constitutional component represented by Formula (1) described later and has at least one block chain having a C Log P value of 1 or less.

The block chain having a C Log P value of 1 or less (hereinafter, may be referred to as a polar block chain) is directly or indirectly adjacent (bonded) to at least one terminal block chain. In the present invention, the description that the block chain is adjacent means that two block chains are bonded without interposing another block chain, and it includes both aspects of an aspect in which the end parts of two block chains are directly connected to each other and an aspect in which two block chains are indirectly bonded through a linking group or the like, which is not the block chain. The linking group or the like is ambiguously determined according to the polymerization method, the block chain bonding method, the chain transfer agent to be used, and the like, and an appropriate group, generally an organic group, can be applied.

Each of the numbers of terminal block chains and polar block chains contained in the block polymerized chain is ambiguously determined according to the molecular structure (the polymer chain structure) of the block polymerized chain or block polymer, the number of bonds of block chains, and the like, and it is appropriately selected. For example, in a case where the polymer chain structure of the block polymer is linear and the number of bonds is small, the number of terminal block chains is one, and the number of polar block chains is one (the following binary block copolymerized chain). The polymer chain structure of the block polymerized chain is not particularly limited and may be a linear structure or a branched structure (a graft structure, a star-shaped structure, a comb-shaped structure, or the like); however, it is preferably a linear structure.

The structure of the block polymerized chain (the bonding form of the block chain) is not particularly limited as long as at least one of the block chains located at the terminal of the block polymerized chain is the above-described terminal block chain, and the remaining block chains located at the terminal of the block polymerized chain may be a polar block chain or may be a block chain other than the terminal block chain and the polar block chain.

Examples of the structure of the block polymerized chain include an A-B block polymerized chain structure in a case where the terminal block chain (segment) is denoted by “A” and the polar block chain (segment) is denoted by “B”. Among the above, an A-(B)n-block polymerized chain structure or an A-(B)n-A block polymerized chain structure is preferable. In both block polymerized chain structures, n is an integer of 1 or more and preferably 1 (a binary block copolymerized chain). It is noted that in a case where n is an integer of 2 or more, the two adjacent polar block chains B are block chains different from each other. In a case where the block polymerized chain has a block chain other than the terminal block chain and the polar block chain, and this block chain is denoted by “C”, examples of the structure of the block polymerized chain include an A-B-C block polymerized chain structure.

—Terminal Block Chain—

The terminal block chain that forms the block polymerized chain may be any chain that is located at the terminal of the block copolymerized chain; however, it is preferably a block chain that is located at the terminal of the block polymer in a case where the block polymerized chain is incorporated into the block polymer. The terminal block chain does not include a terminal group bonded to the terminal thereof.

This terminal block chain has a constitutional component represented by Formula (1), and has a C Log P value of 2 or more. In a case where the C Log P value of the terminal block chain is 2 or more, it is possible for the block polymer to form binder particles having a predetermined size. In particular, from the viewpoints that the dispersion stability of solid particles can be further enhanced and that both the dispersion stability (the lower resistance) of solid particles and the binding property between solid particles can be achieved at a high level, the C log P value of the terminal block chain can also be set to preferably 2.5 or more, more preferably 3.5 or more, and still more preferably 4 or more. The upper limit value of the C Log P value is not particularly limited, and it is practically 10 or less and preferably 7 or less.

The C Log P value of the terminal block chain means the C Log P value of the entire terminal block chain. That is, it is a value calculated based on the constitutional components that form the terminal block chain and mole fractions thereof, and the terminal group bonded to the terminal block chain is not considered (not included in the calculation). Further, the C Log P value of each constitutional component is a value of a compound (a polymerizable compound) from which constitutional component is derived, not a value in a state of being (not a value of a form after polymerization, for example, a structure represented by Formula (1) described later) incorporated into the terminal block chain.

Specifically, it is a C Log P value calculated according to following expression.

$$ClogP value = {P}_{C 1} \times {M}_{C 1} + {P}_{C 2} \times {M}_{C 2} + … + {P}_{Cn} \times {M}_{Cn}$$

Here, P_{C1}, P_{C2}, and P_{Cn} represent the C Log P values of compounds that derive to the constitutional components C1, C2, and Cn, respectively, and M_{C1}, M_{C2}, and M_{Cn} represent mole fractions of the constitutional components C1, C2, and Cn, respectively, in all the constitutional components that form the terminal block chain. n represents the number of kinds of constitutional components that form the terminal block chain, and it is 0 in a case where the number of kinds is 1 or 2, and it is an integer of 3 or more in a case where the number of kinds is 3 or more.

In the present invention, the C Log P value is a value obtained by calculating the common logarithm Log P of the partition coefficient P between 1-octanol and water regarding a component from which each constitutional component is derived. Known methods and software can be used for calculating the C Log P value. However, unless specified otherwise, a value calculated from a structure that is drawn by using ChemDraw of PerkinElmer, Inc. is used.

In the present invention, the C Log P value of the terminal block chain can be adjusted with the kind and content of the compound from which the constitutional component is derived, and the C Log P value of the compound from which the constitutional component is derived can be appropriately adjusted with, for example, the number of carbon atoms of Rb or the substituent which may be optionally contained, in a case of a constitutional component represented by Formula (1).

The terminal block chain has a constitutional component represented by Formula (1). This makes it possible for the C Log P value of the terminal block chain to be easily adjusted to the above range and makes it possible to enhance the dispersion stability of the solid particles.

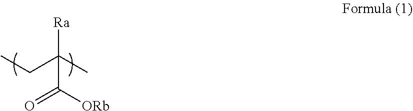

In Formula (1), Ra represents a hydrogen atom, a hydroxy group, a cyano group, a halogen atom (a fluorine atom, a chlorine atom, a bromine atom, an iodine atom, or the like), or an alkyl group having 1 to 6 carbon atoms, and it is preferably a hydrogen atom or an alkyl group. The alkyl group that can be adopted as Ra may be any one of a linear chain, a branched chain, or a cyclic chain, and it preferably has 1 to 3 carbon atoms and more preferably 1 carbon atom.

Rb represents a linear or branched alkyl group having 3 or more carbon atoms. It suffices that alkyl group that can be adopted as Rb may be any group other than the cyclic alkyl group, and it is preferably a linear alkyl group. The number of carbon atoms of the alkyl group that can be adopted as Rb is preferably 6 or more, more preferably 8 or more, and still more preferably 10 or more, and particularly preferably 12 or more, particularly from the viewpoint that the dispersion stability of the solid particles can be further enhanced. The upper limit of the number of carbon atoms of this alkyl group is not particularly limited, and it is practically 25 or less, preferably 20 or less, and more preferably 15 or less.

Terminal block chain preferably contains at least two kinds of constitutional components, including the constitutional components represented by Formula (1). It suffices that the two kinds of constitutional components contain at least one constitutional component represented by Formula (1), and they include both aspects of an aspect consisting of a constitutional component represented by Formula (1) and an aspect consisting of a constitutional component by Formula (1) and another constitutional component. The number of kinds of constitutional components contained in the terminal block chain is preferably 2 or more, more preferably 2 to 5, and still more preferably 2 or 3. The terminal block chain is preferably a chain consisting of two kinds of chains, including one kind of constitutional component represented by Formula (1) and one kind of another constitutional component.

Examples of the other constitutional component contained in the terminal block chain include constitutional components derived from a compound copolymerizable with the constitutional component represented by Formula (1), which include, for example, a constitutional component derived from an ethylenically unsaturated bond-containing compound.

Examples of the ethylenically unsaturated bond-containing compound is not particularly limited, and examples thereof include (meth)acrylic compounds such as a (meth)acrylic acid compound, a (meth)acrylic acid ester compound, a (meth)acrylamide compound, and a (meth)acrylic nitrile compound; and vinyl compounds such as a styrene compound, a vinylnaphthalene compound, a vinylcarbazole compound, an allyl compound, a vinyl ether compound, a vinyl ester compound, a dialkyl itaconate compounds, and an unsaturated carboxylic acid anhydride. Among them, a (meth)acrylic compound is preferable, a (meth)acrylic acid compound or a (meth)acrylic acid ester compound is more preferable, and a (meth)acrylic acid ester compound is still more preferable. Examples of the (meth)acrylic acid ester compound include various ester compounds of (meth)acrylic acid, which include, for example, an alkyl ester compound, an aryl ester compound, and a heterocyclic ester compound, and an alkyl ester compound is preferable.

As the ethylenically unsaturated bond-containing compound, a known compound can be used without particular limitation. Further, the alkyl group, the aryl group, and the heterocyclic group, which form each ester compound, are not particularly limited, and examples thereof include respective groups in the substituent Z described later. However, the (meth)acrylic acid alkyl ester compound is different from the compound that derives the constitutional components represented by Formula (1), and specific example thereof include a (meth)acrylic acid methyl ester compound, a (meth)acrylic acid ethyl ester compound, and a (meth)acrylic acid cyclohexyl ester compound.

The constitutional component represented by Formula (1) and the other constitutional component may have a substituent. The substituent is not particularly limited, and examples thereof preferably include a group selected from the substituent Z described later. It is also one of the preferred aspects that the substituent is a substituent other than the functional group selected from the group G of functional groups described later, in terms of the C Log P value. It is one of the preferred aspects that the constitutional component represented by Formula (1) does not have a substituent.

The terminal block chain is preferably a block chain formed of a constitutional component represented by Formula (1) or a block chain formed of a constitutional component represented by Formula (1) and a constitutional component derived from an ethylenically unsaturated bond-containing compound, more preferably a block chain formed of a constitutional component represented by Formula (1) or a block chain formed of a constitutional component represented by Formula (1) and a constitutional component of a short-chain alkyl group, the constitutional component being derived from a (meth)acrylic acid ester compound, and in terms of achieving both the dispersion stability of solid particles and the binding property of solid particles at a high level, still more preferably a block chain formed of a constitutional component represented by Formula (1) and a constitutional component of a short-chain alkyl group, the constitutional component being derived from a (meth)acrylic acid ester compound.

In a case where the terminal block chain is a copolymerized chain of the constitutional component represented by Formula (1) and the other constitutional component such as a constitutional component derived from an ethylenically unsaturated bond-containing compound, the bonding form of each constitutional component in the terminal block chain is not particularly limited, and it may be a random bond (a random copolymerized chain) or may be an alternate bond (an alternate copolymerized chain); however, it is preferably a random bond.

The content of the constitutional component represented by Formula (1) in the terminal block chain is not particularly limited, and it is appropriately determined in consideration of the C Log P value. For example, the content of the constitutional component represented by Formula (1) is preferably 10% by mole or more, more preferably 20% by mole or more, and still more preferably 30% by mole or more, with respect to all the constitutional components. The upper limit thereof is not particularly limited, and it may be 100% by mole and preferably 90% by mole or less. In a case where the terminal block chain is a copolymerized chain, the lower limit of the content of the constitutional component represented by Formula (1) is as described above, and the upper limit thereof is preferably 90% by mole or less, more preferably 80% by mole or less, still more preferably 70% by mole or less, and particularly preferably 50% by mole or less.

The content of the other constitutional component (the constitutional component derived from the ethylenically unsaturated bond-containing compound) in the terminal block chain is not particularly limited, and the other constitutional component is appropriately determined in consideration of the C Log P value. For example, it is preferably 10% by mole or more, more preferably 20% by mole or more, still more preferably 30% by mole or more, and particularly preferably 50% by mole or more, with respect to all the constitutional components. The upper limit thereof is preferably 90% by mole or less, more preferably 80% by mole or less, and still more preferably 70% by mole or less.

—Polar Block Chain—

The polar block chain that forms the block polymerized chain is a block chain that is bonded adjacent to the terminal block chain in the block copolymerized chain as well as in a case where the block polymerized chain is incorporated into the block polymer. The polar block chain does not include a terminal group bonded to the terminal thereof.

The chemical structure of this polar block chain is not particularly limited as long as the C Log P value is 1 or less. In a case where the C Log P value of the polar block chain is 1 or less, it is possible for the block polymer to form binder particles having a predetermined size, and it is possible to achieve both the dispersion stability (the lower resistance) of solid particles and the binding property of solid particles at a high level. In particular, the C Log P value of the polar block chain is preferably 0.9 or less, more preferably 0.8 or less, and still more preferably 0.7 or less, from the viewpoint that the binding property between solid particles can be further enhanced. The lower limit value of the C Log P value is not particularly limited, and it is practically −3 or more and preferably −2 or more.

The C Log P value of the polar block chain means the C Log P value of the entire polar block chain. That is, it is a value calculated based on the constitutional components that form the polar block chain and mole fractions thereof, and a terminal group is not considered (not included in the calculation) in a case where this terminal group is bonded to the polar block chain. Further, the C Log P value to be employed is a value of a compound (a polymerizable compound) that derives to constitutional component, not a value in a state of being (not a value of a form after polymerization) incorporated into the terminal block chain.

The C Log P value of the polar block chain can be calculated in the same manner as that of the terminal block chain.

The difference in the C Log P value between the polar block chain and at least one terminal block chain [the C Log P value of the terminal block chain—the C Log P value of the polar block chain] is not particularly limited; however, it can be set to 1 to 20, preferably 2 to 15, and still more preferably 3 to 10, from the viewpoint that the dispersion stability (the lower resistance) of the solid particles and the binding property between the solid particles can be achieved in a well-balanced manner.

The C Log P value of the polar block chain can be adjusted with the kind and content of the compound from which, and the C Log P value of the compound that derives the constitutional component can be appropriately adjusted depending on, for example, the chemical structure of the copolymerizable compound and the presence or absence of the functional group selected from the group G of functional groups.

The polymerizable compound from which the constitutional component that constitutes the polar block chain is derived is not particularly limited as long as the C Log P value is satisfied; however, examples thereof include a copolymerizable compound from which D in Formula (3) is derived. Among the above, it is preferably (meth)acrylic acid or a (meth)acrylic acid ester compound and more preferably a (meth)acrylic acid alkyl ester compound. The polymerizable compound may have a substituent. The substituent is not particularly limited, and examples thereof include a group selected from the substituent Z described later. Among the above, it is preferable to have a functional group selected from the following group G of functional groups in terms of the C log P value.

The polar block chain may contain a constitutional component derived from a compound other than the copolymerizable compound from which D in Formula (3) is derived, as long as the C Log P value is 1 or less. Such a compound is not particularly limited, and examples thereof include a constitutional component that forms the terminal block chain. In a case where such a constitutional component is contained, the bonding form of the constitutional component in the polar block chain is not particularly limited.

<The Group G of Functional Groups>

A hydroxy group, a mercapto group, a carboxy group, a phosphate group, an amino group, a cyano group, an isocyanate group, an amide group (preferably an amide group having 1 to 10 carbon atoms), a urea group (preferably a urea group having 1 to 10 carbon atoms), a urethane group (preferably a urethane group having 1 to 10 carbon atoms), an imide group (preferably an imide group having 2 to 12 carbon atoms), and an isocyanurate group

The functional group belonging to the group G of functional groups has a physical or chemical adsorption ability to the surface of the inorganic solid electrolyte, and thus the block polymer exhibits a firm binding property to the inorganic solid electrolyte. Among the functional groups belonging to the group G of functional groups, a hydroxy group, a carboxy group, a cyano group, an amide group, a urea group, or a urethane group is preferable in terms of having a particularly high affinity to the inorganic solid electrolyte.

The amide group, the urea group, the urethane group, and imide group are not particularly limited as long as they are groups respectively contains an amide bond (—CO—NR—), a urea bond (—NR—CO—NR—), a urethane bond (—NR—CO—O—), and an imide bond (—CO—NR—CO—). R is synonymous with RP described later. One bond portion in each of the above bonds is bonded to the polar block chain, and the other bond portion is bonded to any substituent (for example, the substituent Z described later). The isocyanurate group represent a group having an isocyanurate ring skeleton.

The constitutional component that constitutes the polar block chain may be one kind or two or more kinds as long as it contains a constitutional component having a C Log P value of 1 or less, and it may contain a constitutional component having a C Log P value of more than 1.

In the polar block chain, the content of the constitutional component having a C Log P value of 1 or less is not particularly limited, and it is preferably 20% by mole or more, more preferably 30% by mole or more, and still more preferably 40% by mole or more, with respect to all the constitutional components. In a case where the polar block chain is a copolymerized chain, the lower limit of the content of the constitutional component having a C Log P value of 1 or less is as described above.

The contents of the terminal block chain and the polar block chain in the block polymer are unambiguous since they vary according to each of the aspect in which the block polymer contains the block polymerized chain, the average particle diameter of the binder particles, the binding property between the solid particles, and the like, and they can be appropriately set in consideration of these.

For example, in a case where the block polymer is represented by Formula (2), the above content of the terminal block chain in the block polymerized chain is preferably 80% by mole or less, more preferably 60% by mole or less, still more preferably 45% by mole or less, and particularly preferably 35% by mole or less, from the viewpoints that the block polymer easily forms binder particles having a predetermined size and that the binding property between the solid particles can be improved. The lower limit value thereof is practically 10% by mole or more, and it is preferably 20% by mole or more and more preferably 30% by mole or more in terms of dispersion stability of the solid particles.

Further, the above content of the polar block chain in the block polymerized chain is preferably 90% by mole or less, more preferably 80% by mole or less, and still more preferably 70 mole or less, from the viewpoints that the block polymer easily forms binder particles having a predetermined size and in terms of the dispersion stability of the solid particles. The lower limit value thereof is practically 20% by mole or more, preferably 40% by mole or more, more preferably 55% by mole or more, and still more preferably 65% by mole or more, from the viewpoint that the binding property between solid particles can be improved.

It is noted that in a case where the block polymerized chain has a plurality of terminal block chains or polar block chains, the content of each of the block chains shall be the total content thereof.

In a case where the block polymer is represented by Formula (3), the above content of the terminal block chain in the block polymerized chain C is preferably 90% by mole or less, more preferably 85% by mole or less, and still more preferably 80% by mole or less. The lower limit value thereof is preferably 10% by mole or more, more preferably 20% by mole or more, and still more preferably 30% by mole or more.

The above content of the polar block chain in the block polymerized chain is preferably 60% by mole or less, more preferably 50% by mole or less, still more preferably 40% by mole or less. The lower limit value thereof is practically 5% by mole or more, and it is preferably 10% by mole or more and more preferably 15% by mole or more.

In a case where the block polymer has a block chain other than the terminal block chain and the polar block chain, the content of this block chain in the block polymer is not particularly limited and is set appropriately. Generally, each content is set so that the total content of the terminal block chain and the polar block chain is 100% by mole. For example, it can be set to 20% by mole or less.

The block polymer having the above-described block polymerized chain can be appropriately synthesized according to a conventional synthesis method for a block polymer, for example, a synthetic method described in WO2017/030154A, 2011-054439A, WO2011/037254A, or 2012-204303A. For example, a block polymer containing the block polymerized chain as a main chain can be synthesized (polymerized) according to the living polymerization method. Further, the block polymer containing the block polymerized chain as a side chain can be synthesized by appropriately copolymerizing a compound into which a polymerized block polymerized chain is introduced, together with a copolymerizable compound as appropriate.

The method of incorporating a substituent or a functional group is not particularly limited, and examples thereof include a method of copolymerizing a compound having a substituent or a functional group, a method of using a polymerization initiator having (generating) a substituent or functional group or a chain transfer agent, and a method of using a polymeric reaction.

The binder particles can be obtained as a dispersion medium of a particulate block polymer depending on the synthesis (polymerization) method or conditions of the block polymer. Further, in a case where the synthesized block polymer is obtained as a solution, a dispersion medium of the particulate block polymer can be obtained by an emulsification method, a solvent substitution method, or the like, which is generally applied. The method of adjusting the average particle diameter of the binder particles can be adjusted with the composition of the block polymer and the mass average molecular weight, as well as the above synthesis conditions and the emulsification conditions.

—Substituent Z—

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, andoleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present specification, the alkyl group generally has a meaning including a cycloalkyl group therein when being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an arakyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group; in the present specification, the aryloxy group has a meaning including an aryloyloxy group therein when being referred to); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); a heterocyclic oxycarbonyl group (a group in which an —O—CO— group is bonded to the above heterocyclic group); an amino group (preferably an amino group having 0 to 20 carbon atoms, an alkylamino group, or an arylamino group, for example, an amino (—NH₂) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, an arylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, a benzoyloxy group, a naphthoyloxy group, or a nicotinoyloxy group); an aryloyloxy group (preferably an aryloyloxy group having 7 to 23 carbon atoms, for example, a benzoyloxy group); a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group), an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group), an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group), an aryloxysilyl group (preferably an aryloxy group having 6 to 42 carbon atoms, for example, a triphenyloxysilyl group), a phosphoryl group (preferably a phosphate group having 0 to 20 carbon atoms, for example, —OP(═O)(RP)₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a phosphonate group (preferably a phosphonate group having 0 to 20 carbon atoms, for example, —PO(OR^{P})₂) a sulfo group (a sulfonate group), a hydroxy group, a sulfanyl group, a carboxy group, a cyano group, and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

(Physical Properties, Characteristics, or the Like of Binder Particle or Block Polymer that Forms Binder Particle)

The water concentration of the binder particle (the block polymer) is preferably 100 ppm (mass basis) or less. Further, as this binder particle, a polymer may be crystallized and dried, or a dispersion liquid of binder particles may be used as it is.

The block polymer that forms binder particles is preferably noncrystalline. In the present invention, the description that a polymer is “noncrystalline” typically refers to that no endothermic peak due to crystal melting is observed when the measurement is carried out at the glass transition temperature.

The block polymer may be a non-crosslinked polymer or a crosslinked polymer. Further, in a case where the crosslinking of the polymer proceeds by heating or application of a voltage, the molecular weight may be larger than the molecular weight described later.

Preferably, the polymer has a mass average molecular weight in the range described below at the start of use of the all-solid state secondary battery.

The mass average molecular weight of the block polymer is not particularly limited. For example, it is preferably 2,000 or more, and it is more preferably 3,000 or more and still more preferably 4,000 or more. The upper limit thereof is practically 5,000,000 or less, preferably 4,000,000 or less, more preferably 3,000,000 or less, and still more preferably 1,000,000 or less. In a case where the main chain has the block polymerized chain, it may be 10,000 or less.

—Measurement of Molecular Weight—

In the present invention, unless specified otherwise, the molecular weight of the polymer (the polymerized chain) refers to a mass average molecular weight or a number average molecular weight in terms of standard polystyrene conversion, determined by gel permeation chromatography (GPC). Regarding the measurement method thereof, basically, a value measured using a method under Conditions 1 or Conditions 2 (preferable) described below is employed. However, depending on the kind of polymer or macromonomer, an appropriate eluent may be appropriately selected and used.

(Conditions 1)

Column: Connect two TOSOH TSKgel Super AWM-H (product name, manufactured by Tosoh Co., Ltd.)

Carrier: 10 mM LiBr/N-methylpyrrolidone

Measurement temperature: 40° C.

Carrier flow rate: 1.0 ml/min

Sample concentration: 0.1% by mass

Detector: refractive indicator (RI) detector

(Conditions 2)

Column: A column obtained by connecting TOSOH TSKgel Super HZM-H, TOSOH TSKgel Super HZ4000, and TOSOH TSKgel Super HZ2,000 (all of which are product names, manufactured by Tosoh Corporation)

Carrier: tetrahydrofuran

Measurement temperature: 40° C.

Carrier flow rate: 1.0 ml/min

Sample concentration: 0.1% by mass

Detector: refractive indicator (RI) detector

Specific examples of the polymer contained in the binder particles include block polymers B-1 to B-16 synthesized in Examples; however, the present invention is not limited thereto.

It suffices that the inorganic solid electrolyte-containing composition according to the embodiment of the present invention contains at least one kind of binder particles, and a binder generally that is used for an all-solid state secondary battery may be contained.

The content of the binder particle in the inorganic solid electrolyte-containing composition is not particularly limited. However, in terms of dispersion stability and binding property, it is preferably 0.1% to 10.0% by mass, more preferably 0.2% to 5.0% by mass, and still more preferably 0.3% to 4.0% by mass, with respect to 100% by mass of the solid content.

In the present invention, the mass ratio [(the mass of the inorganic solid electrolyte+the mass of the active material)/(the total mass of the binder particle)] of the total mass (the total amount) of the inorganic solid electrolyte and the active material to the mass of the binder particle in the solid content of 100% by mass is preferably in a range of 1,000 to 1. Furthermore, this ratio is more preferably 500 to 2 and still more preferably 100 to 10.

<Dispersion Medium>

The inorganic solid electrolyte-containing composition according to the embodiment of the present invention preferably contains a dispersion medium for dispersing each of the above constitutional components.

It suffices that the dispersion medium is an organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersibility can be exhibited. The non-polar dispersion medium generally refers to a solvent having a property of a low affinity to water; however, in the present invention, it is preferably, for example, an dispersion medium having a C log P value of 1.5 to 6, and examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, diethylene glycol, dipropylene glycol, propylene glycol monomethyl ether, diethylene glycol monomethyl ether, propylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, s-caprolactam, formamide, N-methylformamide, acetamide, N-methylacetamide, N,N-dimethylacetamide, N-methylpropanamide, and hexamethylphosphoric amide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, and xylene.

Examples of the aliphatic compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, butyl acetate, propyl acetate, propyl butyrate, isopropyl butyrate, butyl butyrate, isobutyl butyrate, butyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The compound that constitutes the dispersion medium preferably has a C Log P value of 1 or more, more preferably 1.5 or more, still more preferably 2 or more, and particularly preferably 2.5 or more. The upper limit thereof is not particularly limited; however, it is practically 10 or less and preferably 6 or less.

In the present invention, the C Log P value of the dispersion medium is a value obtained by calculating the common logarithm Log P of the partition coefficient P between 1-octanol and water regarding a dispersion medium. The method of calculating the C Log P value is the same as the method of calculating the C Log P value of the above-described constitutional component, except that the calculation is carried out for the compound as the dispersion medium.

In a case where two or more kinds of dispersion media are contained, the C log P value of the dispersion media is the sum of the product of the C log P value and the mass fraction of each of the dispersion media.

The difference in the C Log P value between the dispersion medium and the terminal block chain of the block copolymerized chain [the C Log P value of the terminal block chain−the C Log P value of the dispersion medium] (in terms of absolute value) is not particularly limited; however, it is, for example, preferably 0 to 5, more preferably 0.3 to 4, and still more preferably 0.6 to 3, in terms of dispersion stability.

Examples of such a dispersion medium among those described above include toluene (C Log P=2.5), xylene (C log P=3.12), hexane (C Log P=3.9), heptane (Hep, C Log P=4.4), Octane (C Log P=4.9), cyclohexane (C Log P=3.4), cyclooctane (C Log P=4.5), decalin (C Log P=4.8), diisobutyl ketone (DIBK, C Log P=3.0), dibutyl ether (DBE, C Log P=2.57), butyl butyrate (C Log P=2.8), tributylamine (C Log P=4.8), methyl isobutyl ketone (MIBK, C log P=1.31), and ethylcyclohexane (ECH), C log P=3.4).

The dispersion medium preferably has a boiling point of 50° C. or higher, and more preferably 70° C. or higher at normal pressure (1 atm). The upper limit thereof is preferably 250° C. or lower and more preferably 220° C. or lower.

It suffices that the inorganic solid electrolyte-containing composition according to the embodiment of the present invention contains at least one kind of dispersion medium, and it may contain two or more kinds thereof.

In the present invention, the content of the dispersion medium in the inorganic solid electrolyte-containing composition is not particularly limited and can be appropriately set.

For example, in the inorganic solid electrolyte-containing composition, it is preferably 20% to 80% by mass, more preferably 30% to 70% by mass, and particularly preferably 40% to 60% by mass.

<Active Material>

The inorganic solid electrolyte-containing composition according to the embodiment of the present invention can also contain an active material capable of intercalating and deintercalating an ion of a metal belonging to Group 1 or Group 2 of the periodic table. Examples of such active materials include a positive electrode active material and a negative electrode active material, which will be described later.

In the present invention, the inorganic solid electrolyte-containing composition containing an active material (a positive electrode active material or a negative electrode active material) may be referred to as an electrode composition (a positive electrode composition or a negative electrode composition).

(Positive Electrode Active Material)

The positive electrode active material is an active material capable of intercalating and deintercalating an ion of a metal belonging to Group 1 or Group 2 of the periodic table, and it is preferably one capable of reversibly intercalating and deintercalating a lithium ion. The above-described material is not particularly limited as long as the material has the above-described characteristics and may be a transition metal oxide, an organic substance, or an element, which is capable of being complexed with Li, such as sulfur or the like by disassembling the battery.

Among the above, as the positive electrode active material, transition metal oxides are preferably used, and transition metal oxides having a transition metal element Ma (one or more elements selected from Co, Ni, Fe, Mn, Cu, and V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The amount of the element mixed is preferably 0% to 30% by mole of the amount (100% by mole) of the transition metal element M^{a}. It is more preferable that the transition metal oxide is synthesized by mixing the above constitutional components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂(lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited but is preferably a particulate shape. The average particle diameter (the volume average particle diameter) of the positive electrode active material particles is not particularly limited. For example, it can be set to 0.1 to 50 μm. The average particle diameter of the positive electrode active material particles can be measured using the same method as that of the average particle diameter of the inorganic solid electrolyte. In order to allow the positive electrode active material to have a predetermined particle diameter, an ordinary pulverizer or classifier is used. For example, a mortar, a ball mill, a sand mill, a vibration ball mill, a satellite ball mill, a planetary ball mill, a swirling air flow jet mill, or a sieve is preferably used. During pulverization, it is also possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

A positive electrode active material obtained using a baking method may be used after being washed with water, an acidic aqueous solution, an alkaline aqueous solution, or an organic solvent.

The positive electrode active material may be used singly, or two or more thereof may be used in combination.

In a case of forming a positive electrode active material layer, the mass (mg) (mass per unit area) of the positive electrode active material per unit area (cm²) of the positive electrode active material layer is not particularly limited. It can be appropriately determined according to the designed battery capacity and can be set to, for example, 1 to 100 mg/cm².

The content of the positive electrode active material in the inorganic solid electrolyte-containing composition is not particularly limited; however, it is preferably 10% to 97% by mass, more preferably 30% to 95% by mass, still more preferably 40% to 93% by mass, and particularly preferably 50% to 90% by mass, with respect to 100% by mass of the solid content.

(Negative Electrode Active Material)

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described properties, and examples thereof include a carbonaceous material, a metal oxide, a metal composite oxide, a lithium single body, a lithium alloy, and a negative electrode active material that is capable of forming an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased. In the constitutional layer formed of the solid electrolyte composition according to the embodiment of the present invention, it is possible to maintain a state where solid particles firmly bind to each other, and thus it is possible to use a negative electrode active material capable of forming an alloy with lithium, as the negative electrode active material. As a result, it is possible to increase the capacity of the all-solid state secondary battery and extend battery life.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the planar spacing, density, and crystallite size described in Li ion secondary1987-22066A (Li ion secondary-S62-22066A), Li ion secondary1990-6856A (Li ion secondary-H2-6856A), and Li ion secondary1991-45473A (Li ion secondary-H3-45473A). The carbonaceous material is not necessarily a single material and, for example, may be a mixture of natural graphite and artificial graphite described in Li ion secondary1993-90844A (Li ion secondary-H5-90844A) or graphite having a coating layer described in Li ion secondary1994-4516A (Li ion secondary-H6-4516A).

As the carbonaceous material, hard carbon or graphite is preferably used, and graphite is more preferably used.

The oxide of a metal or a metalloid element that can be used as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are preferably noncrystalline oxides, and more preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “amorphous” represents an oxide having a broad scattering band with a peak in a range of 20° to 40° in terms of 2θ value in case of being measured by an X-ray diffraction method using CuKα rays, and the oxide may have a crystal diffraction line. The highest intensity in a crystal diffraction line observed in a range of 40° to 70° in terms of 2θ is preferably 100 times or less and more preferably 5 times or less relative to the intensity of a diffraction peak line in a broad scattering band observed in a range of 20° to 40° in terms of 2θ, and it is still more preferable that the oxide does not have a crystal diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are more preferable. Specific examples of preferred noncrystalline oxides and chalcogenides include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Preferred examples of the negative electrode active material which can be used in combination with amorphous oxides containing Sn, Si, or Ge as a major constitutional component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, the metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and more specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is an alloy typically used as a negative electrode active material for a secondary battery, and examples thereof include a lithium aluminum alloy.

The negative electrode active material that is capable of forming an alloy with lithium is not particularly limited as long as it is typically used as a negative electrode active material for a secondary battery. Such an active material has a large expansion and contraction due to charging and discharging of the all-solid state secondary battery and accelerates the deterioration of battery performance (for example, an increase in battery resistance). However, since the inorganic solid electrolyte-containing composition according to the embodiment of the present invention contains the above-described binder particles, and thus it is possible to suppress the deterioration of battery performance. Examples of such an active material include a (negative electrode) active material (an alloy or the like) having a silicon element or a tin element and a metal such as Al or In, a negative electrode active material (a silicon-containing active material) having a silicon element capable of exhibiting high battery capacity is preferable, and a silicon-containing active material in which the content of the silicon element is 50% by mole or more with respect to all the constitutional elements is more preferable.

In general, a negative electrode including the negative electrode active material (for example, a Si negative electrode including a silicon-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage that the battery driving duration can be extended.

Examples of the silicon-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of forming an alloy with lithium.

Examples of the negative electrode active material including tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy.

The chemical formulae of the compounds obtained by the above baking method can be calculated using an inductively coupled plasma (ICP) emission spectroscopic analysis method as a measurement method from the mass difference of powder before and after firing as a convenient method.

The shape of the negative electrode active material is not particularly limited but is preferably a particulate shape. The volume average particle diameter of the negative electrode active material is not particularly limited; however, it is preferably 0.1 to 60 μm. The volume average particle diameter of the negative electrode active material particles can be measured using the same method as that of the average particle diameter of the inorganic solid electrolyte. In order to obtain the predetermined particle diameter, a typical pulverizer or classifier is used as in the case of the positive electrode active material.

The negative electrode active material may be used singly, or two or more negative electrode active materials may be used in combination.

In a case of forming a negative electrode active material layer, the mass (mg) (mass per unit area) of the negative electrode active material per unit area (cm²) in the negative electrode active material layer is not particularly limited. It can be appropriately determined according to the designed battery capacity and can be set to, for example, 1 to 100 mg/cm².

The content of the negative electrode active material in the inorganic solid electrolyte-containing composition is not particularly limited, and it is preferably 10% to 90% by mass, more preferably 20% to 85% by mass, still more preferably 30% to 80% by mass, and even still more preferably 40% by mass to 75% by mass with respect to 100% by mass of the solid content.

In the present invention, in a case where a negative electrode active material layer is formed by charging a secondary battery, ions of a metal belonging to Group 1 or Group 2 in the periodic table, generated in the all-solid state secondary battery, can be used instead of the negative electrode active material. By bonding the ions to electrons and precipitating a metal, a negative electrode active material layer can be formed.

(Coating of Active Material) The surfaces of the positive electrode active material and the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, a surface treatment may be carried out on the surfaces of electrodes including the positive electrode active material or the negative electrode active material using sulfur, phosphorous, or the like.

Furthermore, the particle surface of the positive electrode active material or the negative electrode active material may be treated with an actinic ray or an active gas (plasma or the like) before and after the coating of the surfaces.

<Conductive Auxiliary Agent>

The inorganic solid electrolyte-containing composition according to the embodiment of the present invention preferably contains a conductive auxiliary agent, and for example, it is preferable that the silicon atom-containing active material as the negative electrode active material is used in combination with a conductive auxiliary agent.

The conductive auxiliary agent is not particularly limited, and conductive auxiliary agents that are known as ordinary conductive auxiliary agents can be used. The conductive auxiliary agent may be, for example, graphite such as natural graphite or artificial graphite, carbon black such as acetylene black, Ketjen black, or furnace black, amorphous carbon such as needle cokes, a carbon fiber such as a vapor-grown carbon fiber or a carbon nanotube, or a carbonaceous material such as graphene or fullerene which are electron-conductive materials and also may be a metal powder or a metal fiber of copper, nickel, or the like, and a conductive polymer such as polyaniline, polypyrrole, polythiophene, polyacetylene, or a polyphenylene derivative may also be used.

In the present invention, in a case where the active material and the conductive auxiliary agent are used in combination, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not determined unambiguously but is determined by the combination with the active material.

One kind of conductive auxiliary agent may be contained, or two or more kinds thereof may be contained.

The shape of the conductive auxiliary agent is not particularly limited but is preferably a particulate shape.

In a case where the inorganic solid electrolyte-containing composition according to the embodiment of the present invention contains a conductive auxiliary agent, the content of the conductive auxiliary agent in the inorganic solid electrolyte-containing composition is preferably 0% to 10% by mass in the solid content of 100% by mass.

<Lithium Salt>

The inorganic solid electrolyte-containing composition according to the embodiment of the present invention preferably contains a lithium salt (a supporting electrolyte) as well.

Generally, the lithium salt is preferably a lithium salt that is used for this kind of product and is not particularly limited. For example, lithium salts described in paragraphs 0082 to 0085 of 2015-088486A are preferable.

In a case where the inorganic solid electrolyte-containing composition according to the embodiment of the present invention contains a lithium salt, the content of the lithium salt is preferably 0.1 part by mass or more and more preferably 5 parts by mass or more with respect to 100 parts by mass of the solid electrolyte. The upper limit thereof is preferably 50 parts by mass or less and more preferably 20 parts by mass or less.

<Dispersing Agent>

Since the above-described binder particle functions as a dispersing agent as well, the inorganic solid electrolyte-containing composition according to the embodiment of the present invention may not contain a dispersing agent other than this binder particle; however, it may contain a dispersing agent. As the dispersing agent, a dispersing agent that is generally used for an all-solid state secondary battery can be appropriately selected and used. Generally, a compound intended for particle adsorption and steric repulsion and/or electrostatic repulsion is suitably used.

<Other Additives>

As constitutional components other than the respective constitutional components described above, the inorganic solid electrolyte-containing composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant. The ionic liquid is contained in order to further improve the ion conductivity, and the known one in the related art can be used without particular limitation. Further, a polymer other than the block polymer that forms the binder particles described above, or a binding agent other than the binder particles described above, which is generally used for an all-solid state secondary battery, may be contained.

(Preparation of Inorganic Solid Electrolyte-Containing Composition)

The inorganic solid electrolyte-containing composition according to the embodiment of the present invention can be prepared by mixing an inorganic solid electrolyte, binder particles, a dispersion medium, preferably a conductive auxiliary agent, and further appropriately a lithium salt, and any other optionally constitutional components, as a mixture and preferably as a slurry by using, for example, various mixers that are used generally. In a case of an electrode composition, an active material is further mixed.

A mixing method is not particularly limited, and the constitutional components may be mixed at once or sequentially. A mixing environment is not particularly limited, and examples thereof include a dry air environment and an inert gas environment.

[Sheet for an all-Solid State Secondary Battery]

A sheet for an all-solid state secondary battery according to the embodiment of the present invention is a sheet-shaped molded body with which a constitutional layer of an all-solid state secondary battery can be formed, and includes various aspects depending on uses thereof. Examples of thereof include a sheet that is preferably used in a solid electrolyte layer (also referred to as a solid electrolyte sheet for an all-solid state secondary battery), and a sheet that is preferably used in an electrode or a laminate of an electrode and a solid electrolyte layer (an electrode sheet for an all-solid state secondary battery). In the present invention, the variety of sheets described above will be collectively referred to as a sheet for an all-solid state secondary battery.

It suffices that the solid electrolyte sheet for an all-solid state secondary battery according to the embodiment of the present invention a sheet including a solid electrolyte layer, and may be a sheet in which a solid electrolyte layer is formed on a substrate or may be a sheet that is formed of a solid electrolyte layer without including a substrate. The solid electrolyte sheet for an all-solid state secondary battery may include another layer in addition to the solid electrolyte layer. Examples of the other layer include a protective layer (a stripping sheet), a collector, and a coating layer.

Examples of the solid electrolyte sheet for an all-solid state secondary battery according to the embodiment of the present invention include a sheet including a layer constituted of the inorganic solid electrolyte-containing composition according to the embodiment of the present invention, a typical solid electrolyte layer, and a protective layer on a substrate in this order. The solid electrolyte layer included in the solid electrolyte sheet for an all-solid state secondary battery is preferably formed of the inorganic solid electrolyte-containing composition according to the embodiment of the present invention. The contents of the respective constitutional components in the solid electrolyte layer are not particularly limited; however, the contents are preferably the same as the contents of the respective constitutional components with respect to the solid content of the inorganic solid electrolyte-containing composition according to the embodiment of the present invention. The layer thickness of each layer that constitutes the solid electrolyte sheet for an all-solid state secondary battery is the same as the layer thickness of each layer described later in the all-solid state secondary battery.

The substrate is not particularly limited as long as it can support the solid electrolyte layer, and examples thereof include a sheet body (plate-shaped body) formed of materials described below regarding the collector, an organic material, an inorganic material, or the like. Examples of the organic materials include various polymers, and specific examples thereof include polyethylene terephthalate, polypropylene, polyethylene, and cellulose. Examples of the inorganic materials include glass and ceramic.

It suffices that the electrode sheet for an all-solid state secondary battery according to the embodiment of the present invention (simply also referred to as an “electrode sheet”) is an electrode sheet including an active material layer, and may be a sheet in which an active material layer is formed on a substrate (collector) or may be a sheet that is formed of an active material layer without including a substrate. The electrode sheet is typically a sheet including the collector and the active material layer, and examples of an aspect thereof include an aspect including the collector, the active material layer, and the solid electrolyte layer in this order and an aspect including the collector, the active material layer, the solid electrolyte layer, and the active material layer in this order. The solid electrolyte layer and the active material layer included in the electrode sheet are preferably formed of the inorganic solid electrolyte-containing composition according to the embodiment of the present invention. The contents of the respective constitutional components in this solid electrolyte layer or active material layer are not particularly limited; however, the contents are preferably the same as the contents of the respective constitutional components with respect to the solid content of the inorganic solid electrolyte-containing composition (the electrode composition) according to the embodiment of the present invention. The layer thickness of each of the layers forming the electrode sheet according to the embodiment of the present invention is the same as the layer thickness of each of the layers described below regarding the all-solid state secondary battery. The electrode sheet according to the embodiment of the present invention may include the above-described other layer.

In the sheet for an all-solid state secondary battery according to the embodiment of the present invention, at least one layer of the solid electrolyte layer or the active material layer is formed of the inorganic solid electrolyte-containing composition according to the embodiment of the present invention. As a result, in a case where the sheet for an all-solid state secondary battery according to the embodiment of the present invention is used as a constitutional layer of the all-solid state secondary battery, it is possible to realize an all-solid state secondary battery having low resistance (high conductivity). As a result, the sheet for an all-solid state secondary battery according to the embodiment of the present invention is suitably used as a sheet with which a constitutional layer of an all-solid state secondary battery can be formed.

[Manufacturing Method for Sheet for all-Solid State Secondary Battery]

The manufacturing method for a sheet for an all-solid state secondary battery according to the embodiment of the present invention is not particularly limited, and the sheet can be manufactured by forming each of the above layers using the inorganic solid electrolyte-containing composition according to the embodiment of the present invention. Examples thereof include a method in which the film formation (the coating and drying) is carried out preferably on a substrate or a collector (the other layer may be interposed) to form a layer (a coated and dried layer) consisting of an inorganic solid electrolyte-containing composition. This method makes it possible to produce a sheet for an all-solid state secondary battery having a substrate or a collector and having a coated and dried layer. Here, the coated and dried layer refers to a layer formed by carrying out coating with the inorganic solid electrolyte-containing composition according to the embodiment of the present invention and drying the dispersion medium (that is, a layer formed using the inorganic solid electrolyte-containing composition according to the embodiment of the present invention and consisting of a composition obtained by removing the dispersion medium from the inorganic solid electrolyte-containing composition according to the embodiment of the present invention). In the active material layer and the coated and dried layer, the dispersion medium may remain within a range where the effects of the present invention do not deteriorate, and the residual amount thereof, for example, in each of the layers may be 3% by mass or lower.

In the manufacturing method for a sheet for an all-solid state secondary battery according to the embodiment of the present invention, each of the steps such as coating and drying will be described in the following manufacturing method for an all-solid state secondary battery.

In the manufacturing method for a sheet for an all-solid state secondary battery according to the embodiment of the present invention, the coated and dried layer obtained as described above can be pressurized. The pressurizing condition and the like will be described later in the section of the manufacturing method for an all-solid state secondary battery.

In addition, in the manufacturing method for a sheet for an all-solid state secondary battery according to the embodiment of the present invention, the base material, the protective layer (particularly stripping sheet), or the like can also be stripped.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The positive electrode active material layer is preferably formed on a positive electrode collector to configure a positive electrode. The negative electrode active material layer is preferably formed on a negative electrode collector to configure a negative electrode.

At least one layer of the negative electrode active material layer, the positive electrode active material layer, or the solid electrolyte layer is formed of the inorganic solid electrolyte-containing composition according to the embodiment of the present invention, and at least one of the solid electrolyte layer, the negative electrode active material layer, or the positive electrode active material layer is preferably formed of the inorganic solid electrolyte-containing composition according to the embodiment of the present invention. It is also one of the preferred aspects that all of the layers are formed of the inorganic solid electrolyte-containing composition according to the embodiment of the present invention. In the active material layer or the solid electrolyte layer formed of the inorganic solid electrolyte-containing composition according to the embodiment of the present invention, the kinds of constitutional components to be contained and the content ratios thereof are preferably the same as the solid content of the inorganic solid electrolyte-containing composition according to the embodiment of the present invention. In a case where the active material layer or the solid electrolyte layer is not formed of the inorganic solid electrolyte-containing composition according to the embodiment of the present invention, a known material in the related art can be used.

The thickness of each of the negative electrode active material layer, the solid electrolyte layer, and the positive electrode active material layer is not particularly limited. In case of taking a dimension of an ordinary all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

Each of the positive electrode active material layer and the negative electrode active material layer may include a collector on the side opposite to the solid electrolyte layer.

<Housing>

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

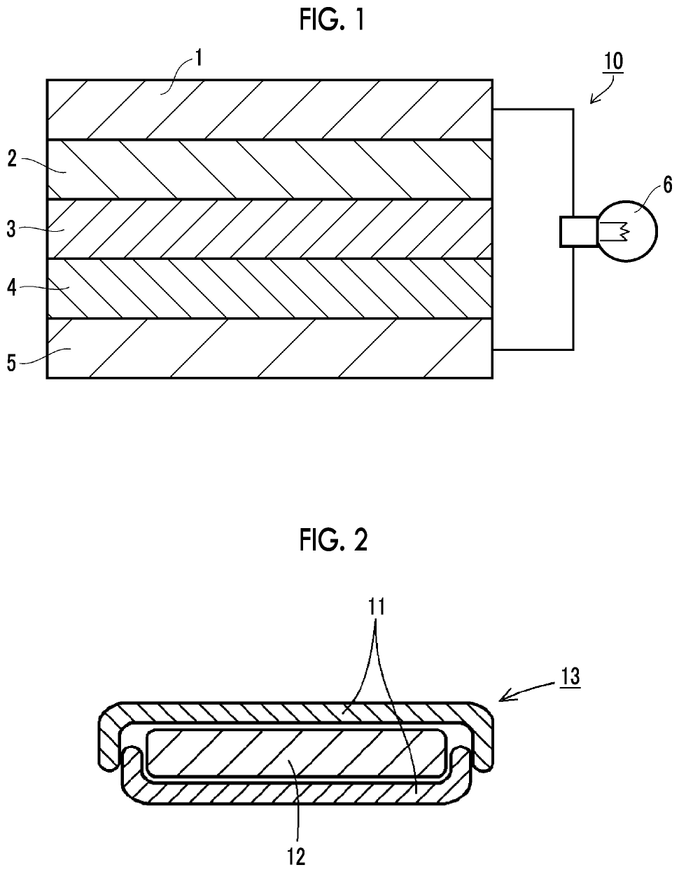

Hereinafter, the all-solid state secondary battery of the preferred embodiments of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In the case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode side return to the positive electrode, and electrons are supplied to an operation portion 6. In an example illustrated in the drawing, an electric bulb is employed as a model at the operation portion 6 and is lit by discharging.

In a case where the all-solid state secondary battery having a layer constitution illustrated in FIG. 1 is put into a 2032-type coin case, the all-solid state secondary battery will be referred to as the “laminate for an all-solid state secondary battery”, and a battery prepared by putting this laminate for an all-solid state secondary battery into a 2032-type coin case (For example, the coin-type all-solid state secondary battery illustrated in FIG. 2) will be referred to as an “all-solid state secondary battery”, whereby both batteries may be distinctively referred to in some cases.

(Positive Electrode Active Material Layer, Solid Electrolyte Layer, and Negative Electrode Active Material Layer)

In the all-solid state secondary battery 10, all of the positive electrode active material layer, the solid electrolyte layer, and the negative electrode active material layer are formed of the inorganic solid electrolyte-containing composition of the embodiment of the present invention. This all-solid state secondary battery 10 exhibits excellent battery performance. The kinds of the inorganic solid electrolyte and the binder particle, which are contained in the positive electrode active material layer 4, the solid electrolyte layer 3, and the negative electrode active material layer 2, may be identical to or different from each other.

In the present invention, any one of the positive electrode active material layer and the negative electrode active material layer, or collectively both of them may be simply referred to as an active material layer or an electrode active material layer. In addition, in the present invention, any one of the positive electrode active material and the negative electrode active material, or collectively both of them may be simply referred to as an active material or an electrode active material.

In the present invention, in a case where the constitutional layer is formed of the inorganic solid electrolyte-containing composition according to the embodiment of the present invention, it is possible to realize an all-solid state secondary battery having low resistance.

In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the above thickness of the above negative electrode active material layer.

The positive electrode collector 5 and the negative electrode collector 1 are preferably an electron conductor.

In the present invention, either or both of the positive electrode collector and the negative electrode collector will also be collectively referred to as simply the collector.

As a material that forms the positive electrode collector, not only aluminum, an aluminum alloy, stainless steel, nickel, or titanium but also a material (a material on which a thin film is formed) obtained by treating the surface of aluminum or stainless steel with carbon, nickel, titanium, or silver is preferable. Among these, aluminum or an aluminum alloy is more preferable.

As a material which forms the negative electrode collector, aluminum, copper, a copper alloy, stainless steel, nickel, titanium, or the like, and further, a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, a film sheet shape is typically used; however, it is also possible to use shapes such as a net shape, a punched shape, a lath body, a porous body, a foaming body, and a molded body of fiber.

The thickness of the collector is not particularly limited; however, it is preferably 1 to 500 μm. In addition, protrusions and recesses are preferably provided on the surface of the collector by carrying out a surface treatment.

In the all-solid state secondary battery 10, a layer formed of a known constitutional layer forming material can be applied to the positive electrode active material layer.

In the present invention, a functional layer, a functional member, or the like may be appropriately interposed or disposed between each layer of the negative electrode collector, the negative electrode active material layer, the solid electrolyte layer, the positive electrode active material layer, and the positive electrode collector or on the outside thereof. In addition, each layer may be constituted of a single layer or multiple layers.

[Manufacture of all-Solid State Secondary Battery]

The all-solid state secondary battery can be manufactured by a conventional method. Specifically, the all-solid state secondary battery can be manufactured by forming each of the layers described above using the inorganic solid electrolyte-containing composition of the embodiment of the present invention or the like. Hereinafter, the manufacturing method therefor will be described in detail.

The all-solid state secondary battery according to the embodiment of the present invention can be manufactured by carrying out a method (a manufacturing method for a sheet for an all-solid state secondary battery according to the embodiment of the present invention) including (undergoing) a step of coating an appropriate base material (for example, a metal foil which serves as a collector) with the inorganic solid electrolyte-containing composition according to the embodiment of the present invention and forming a coating film (forming a film).

For example, an inorganic solid electrolyte-containing composition containing a positive electrode active material is applied as a material for a positive electrode (a positive electrode composition) onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied onto the positive electrode active material layer to form the solid electrolyte layer. Furthermore, an inorganic solid electrolyte-containing composition containing a negative electrode active material is applied as a material for a negative electrode (a negative electrode composition) onto the solid electrolyte layer, to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by sealing the all-solid state secondary battery in a housing.

In addition, it is also possible to manufacture an all-solid state secondary battery by carrying out the forming method for each layer in reverse order to form a negative electrode active material layer, a solid electrolyte layer, and a positive electrode active material layer on a negative electrode collector and overlaying a positive electrode collector thereon.

As another method, the following method can be exemplified. That is, the positive electrode sheet for an all-solid state secondary battery is produced as described above. In addition, an inorganic solid electrolyte-containing composition containing a negative electrode active material is applied as a material for a negative electrode (a negative electrode composition) onto a metal foil which is a negative electrode collector, to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated with each other to sandwich the solid electrolyte layer that has been peeled off from the base material. In this manner, an all-solid state secondary battery can be manufactured.

Further, a positive electrode sheet for an all-solid state secondary battery, a negative electrode sheet for an all-solid state secondary battery, and a solid electrolyte sheet for an all-solid state secondary battery are produced as described above. Next, the positive electrode sheet for an all-solid state secondary battery or negative electrode sheet for an all-solid state secondary battery, and the solid electrolyte sheet for an all-solid state secondary battery are overlaid and pressurized into a state where the positive electrode active material layer or the negative electrode active material layer is brought into contact with the solid electrolyte layer. In this manner, the solid electrolyte layer is transferred to the positive electrode sheet for an all-solid state secondary battery or the negative electrode sheet for an all-solid state secondary battery. Then, the solid electrolyte layer from which the substrate of the solid electrolyte sheet for an all-solid state secondary battery has been peeled off and the negative electrode sheet for an all-solid state secondary battery or positive electrode sheet for an all-solid state secondary battery are overlaid and pressurized (into a state where the negative electrode active material layer or positive electrode active material layer is brought into contact with the solid electrolyte layer). In this manner, an all-solid state secondary battery can be manufactured. The pressurizing method and the pressurizing conditions in this method are not particularly limited, and a method and pressurizing conditions described in the pressurization of the applied composition, which will be described later, can be applied.

The solid electrolyte layer or the like can also be formed on the substrate or the active material layer, for example, by pressure-molding the inorganic solid electrolyte-containing composition or the like under a pressurizing condition described below, or the solid electrolyte or a sheet molded body of the active material.

In the above production method, it suffices that the inorganic solid electrolyte-containing composition according to the embodiment of the present invention is used in any one of the positive electrode composition, the inorganic solid electrolyte-containing composition, or the negative electrode composition. The inorganic solid electrolyte-containing composition according to the embodiment of the present invention is preferably used in the inorganic solid electrolyte-containing composition, and the inorganic solid electrolyte-containing composition according to the embodiment of the present invention can be also used in any of the compositions.

In a case where the solid electrolyte layer or the active material layer is formed of a composition other than the solid electrolyte composition according to the embodiment of the present invention, examples of the material thereof include a typically used composition. In addition, the negative electrode active material layer can also be formed by binding ions of a metal belonging to Group 1 or Group 2 in the periodic table, which are accumulated on a negative electrode collector during initialization described below or during charging for use, without forming the negative electrode active material layer during the manufacturing of the all-solid state secondary battery to electrons and precipitating the ions on a negative electrode collector or the like as a metal.

<Formation of Individual Layer (Film Formation)>

The method for applying the inorganic solid electrolyte-containing composition is not particularly limited and can be appropriately selected. Examples thereof include coating (preferably wet-type coating), spray coating, spin coating, dip coating, slit coating, stripe coating, and bar coating.

In this case, the inorganic solid electrolyte-containing composition may be dried after being applied each time or may be dried after being applied multiple times. The drying temperature is not particularly limited. The lower limit is preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (coated and dried layer). This temperature range is preferable since the temperature is not excessively increased and each member of the all-solid state secondary battery is not impaired. As a result, excellent overall performance is exhibited in the all-solid state secondary battery, and it is possible to obtain good binding property and good ion conductivity even without pressurization.

In a case where the inorganic solid electrolyte-containing composition according to the embodiment of the present invention is applied and dried as described above, it is possible to suppress the variation in the contact state and to cause solid particles to bind to each other.

After applying the inorganic solid electrolyte-containing composition, it is preferable to pressurize each layer or the all-solid state secondary battery after superimposing the constitutional layers or producing the all-solid state secondary battery. Examples of the pressurizing method include a method using a hydraulic cylinder pressing machine. The pressurizing force is not particularly limited; however, it is generally preferably in a range of 5 to 1,500 MPa.

In addition, the applied inorganic solid electrolyte-containing composition may be heated at the same time with the pressurization. The heating temperature is not particularly limited but is generally in a range of 30° C. to 300° C. The press can also be applied at a temperature higher than the glass transition temperature of the inorganic solid electrolyte. It is also possible to carry out press at a temperature higher than the glass transition temperature of the block polymer contained in the binder particle. However, in general, the temperature does not exceed the melting point of this polymer.

The pressurization may be carried out in a state where the coating solvent or dispersion medium has been dried in advance or in a state where the solvent or the dispersion medium remains.

The respective compositions may be applied at the same time, and the application, the drying, and the pressing may be carried out simultaneously and/or sequentially. Each of the compositions may be applied onto each of the separate base materials and then laminated by carrying out transfer.

The atmosphere during the manufacturing process, for example, during coating, heating, or pressurization, is not particularly limited and may be any one of the atmospheres such as an atmosphere of dried air (the dew point: −20° C. or lower) and an atmosphere of inert gas (for example, an argon gas, a helium gas, or a nitrogen gas).

The pressurization time may be a short time (for example, within several hours) under the application of a high pressure or a long time (one day or longer) under the application of an intermediate pressure. In case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure may be variable depending on the area or the film thickness of the portion under pressure. In addition, the pressure may also be variable stepwise for the same portion.

A pressing surface may be flat or roughened.

<Initialization>

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

[Use Application of all-Solid State Secondary Battery]

The all-solid state secondary battery according to the embodiment of the present invention can be applied to a variety of use applications. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of the consumer usage thereof include an automobile, an electric vehicle, a motor, a lighting instrument, a toy, a game device, a road conditioner, a watch, a strobe, a camera, and a medical device (a pacemaker, a hearing aid, a shoulder massage device, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto to be interpreted. “Parts” and “%” that represent compositions in the following Examples are mass-based unless particularly otherwise described. In the present invention, “room temperature” means 25° C.

1. Polymer Synthesis and Preparation of Binder Solution or Dispersion Liquid

The block polymers B-1 to B-16 and BC-1 to BC-8 shown in the following chemical formulae and Table 1-1 and Table 1-2 (collectively referred to as Table 1) were synthesized as follows, and the binder dispersion liquid or solution of each of the block polymers was prepared.

### Synthesis Example 1: Synthesis of Block Polymer B-1 and Preparation of Binder Dispersion Liquid B-1

Polymer B-1 was synthesized according to the following scheme, and then a dispersion liquid B-1 of this polymer was prepared. In the following scheme, the number in the lower right of each block chain represents the content (% by mole) in the block copolymerized chain (the block polymer), and * represents the bonding site to one of the polymer terminals.

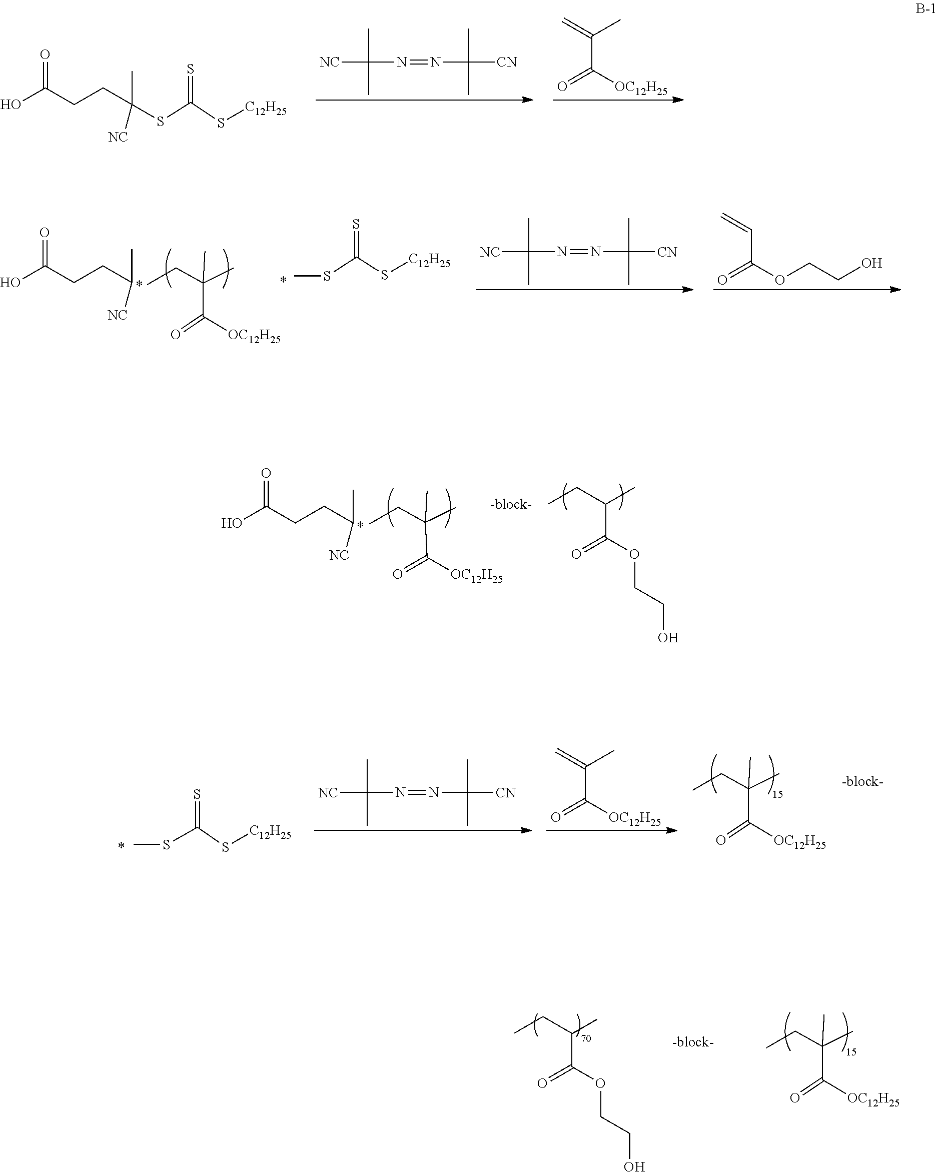

The block polymer B-1 was synthesized in a nitrogen atmosphere.

Specifically, 7.9 g of 4-cyano-4-[(dodecylsulfanylthiocarbonyl)sulfanyl]pentanoic acid (manufactured by FUJIFILM Wako Pure Chemical Corporation) and 22.2 g of butyl butyrate (manufactured by Tokyo Chemical Industry Co., Ltd.) was added to a 300 mL three-necked flask, and the resultant mixture was stirred at 80° C. to be uniformly dissolved. After further adding thereto 0.6 g of 2,2′-azobis (isobutyronitrile) (manufactured by FUJIFILM Wako Pure Chemical Corporation), a solution obtained by dissolving 18.1 g of dodecyl methacrylate (manufactured by FUJIFILM Wako Pure Chemical Corporation) in 7.8 g of butyl butyrate was added dropwise thereto at 80° C. over 2 hours. After the dropwise addition, the mixture was further stirred at the same temperature for 2 hours.

Next, after adding thereto 0.6 g of 2,2′-azobis (isobutyronitrile) to the obtained reaction solution, a solution obtained by dissolving 39.3 g of 2-hydroxyethyl acrylate (manufactured by FUJIFILM Wako Pure Chemical Corporation) in 31.0 g of butyl butyrate was added dropwise thereto at 80° C. over 2 hours. After the dropwise addition, the mixture was further stirred at the same temperature for 2 hours.

Further, after adding thereto 0.6 g of 2,2′-azobis (isobutyronitrile) to the obtained reaction solution, a solution obtained by dissolving 18.1 g of dodecyl methacrylate (manufactured by FUJIFILM Wako Pure Chemical Corporation) in 22.3 g of butyl butyrate was added dropwise thereto at 80° C. over 2 hours. After the dropwise addition, the mixture was further stirred at the same temperature for 2 hours to synthesize a block polymer B-1 consisting of the block polymerized chain shown in the above scheme, whereby a butyl acetate dispersion liquid B-1 (solid content concentration: 50% by mass) of this polymer was obtained

### Synthesis Example 2: Synthesis of Block Polymer B-4 and Preparation of Binder Dispersion Liquid B-4

Polymer B-4 was synthesized according to the following scheme, and then a dispersion liquid B-4 of this polymer was prepared. In the following scheme, the numbers “81” and “1” written in parentheses of the constitutional components that form the main chain, as well as the numbers described in the lower right of the block chain in the block polymerized chain are all indicates the content (% by mole) in the block polymer. * Represents a bonding site to one of the polymer terminals.

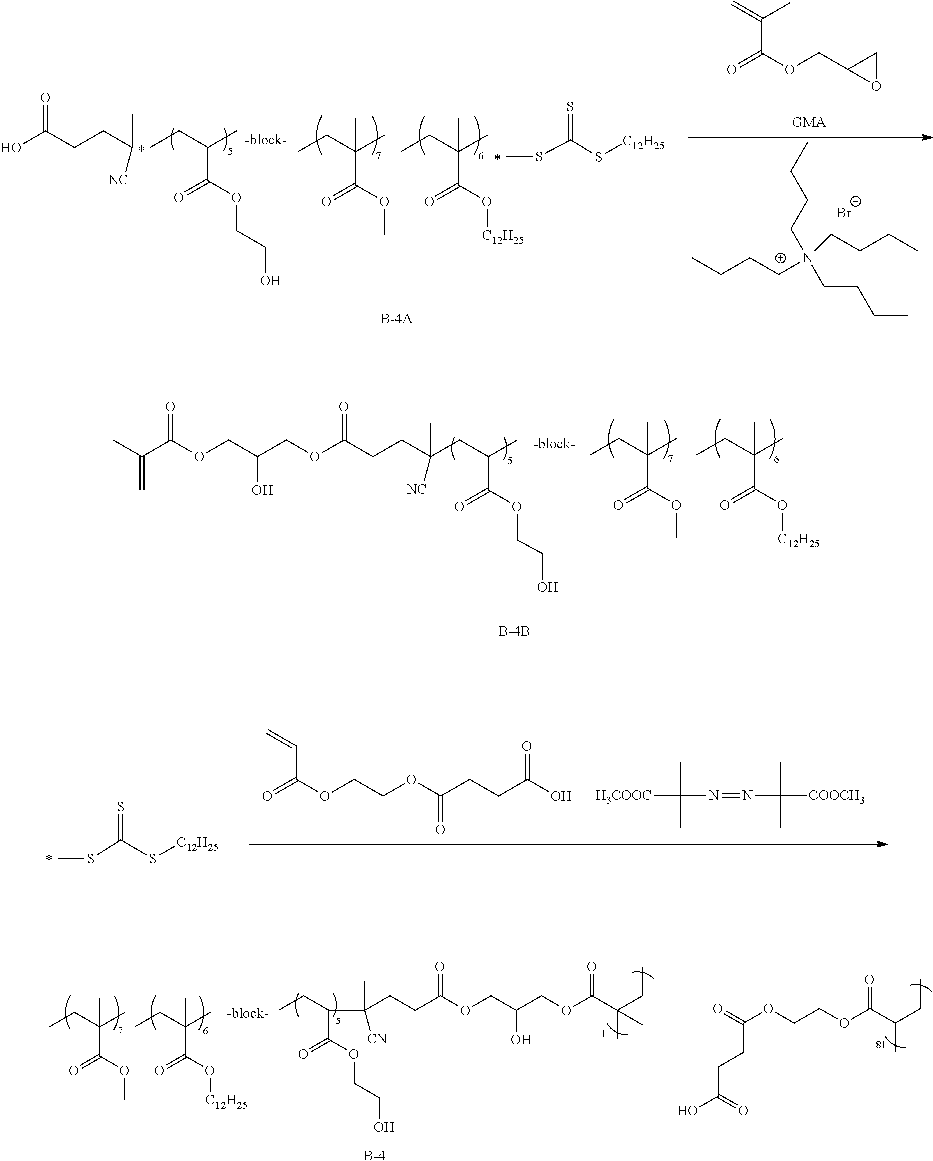

First, isobutyl alcohol was used as a solvent, and a mixture of methyl methacrylate and dodecyl methacrylate (the mixing molar ratio of methyl methacrylate to dodecyl methacrylate is 7:6) was used instead of dodecyl methacrylate, and then block polymerized chain B-4A shown in the above scheme was synthesized in the same manner as in Synthesis Example 1 except that the amount of each compound used was adjusted. It is noted that the block chain containing methyl methacrylate and dodecyl methacrylate in the block polymerized chain B-4A is a block chain consisting of a random copolymer of methyl methacrylate and dodecyl methacrylate.

Next, 30.0 g of the block polymerized chain B-4A, 13.4 g of butyl butyrate, 1.1 g of glycidyl methacrylate (GMA, manufactured by FUJIFILM Wako Pure Chemical Corporation), 0.04 g of a 4-hydroxy-TEMPO free radical (TEMPO: 2,2,6,6-tetramethylpiperidine-1-oxyl, manufactured by Tokyo Chemical Industry Co., Ltd.), and 0.2 g of tetrabutylammonium bromide (manufactured by Tokyo Chemical Industry Co., Ltd.) were added to a 200 mL three-necked flask, and the resultant mixture was stirred at 110° C. for 5 hours. Then, the solvent isobutyl alcohol was substituted with butyl butyrate to synthesize a block polymerized chain B-4B.

Further, 6.2 g of the block polymerized chain B-4B and 3.4 g of butyl butyrate were added to a 200 mL three-necked flask, and the temperature was raised to 80° C. A solution obtained by dissolving 10.5 g of mono(2-acryloyloxyethyl) succinate (manufactured by Tokyo Chemical Industry Co., Ltd.) and 0.1 g of 2,2′-azobis (2-methylpropionic acid) dimethyl (manufactured by FUJIFILM Wako Pure Chemical Corporation) in 60.6 g of butyl butyrate was dropwise added thereto over 4 hours. Then, the mixture was stirred at the same temperature for 2 hours and then at 90° C. for 2 hours to synthesize a block polymer B-4 having a block polymerized chain in the side chain, thereby obtaining a butyl acetate dispersion liquid B-4 (solid content concentration: 15% by mass) of this polymer.

### Synthesis Examples 3 to 12: Synthesis of Block Polymers B-2, B-3, and B-5 to B-12, and Preparation of Binder Dispersion Liquids B-2, B-3, and B-5 to B-12

Block polymers B-2, B-3, and B-5 to B-12 were synthesized in the same manner as in Synthesis Example 1, thereby obtaining binder dispersion liquids B-2, B-3, and B-5 to B-12 (solid content concentration: 50% by mass) consisting of respective block polymers, except that in Synthesis Example 1, a compound from which each constitutional component is derived was adjusted so that the block polymers B-2, B-3, and B-5 to B-12 had the composition (the kind and the content of the constitutional component) shown in Table 1 and the following chemical formula.

It is noted that in the block polymers B-2, B-3, and B-5 to B-12, the block chains containing two kinds of constitutional components are all block chains consisting of random copolymers of compounds from which the respective constitutional components are derived.

### Synthesis Examples 13 to 16: Synthesis of Block Polymers B-13 to B-16, and Preparation of Binder Dispersion Liquids or Solutions B-13 to B-16

Block polymers B-13 to B-16 were synthesized in the same manner as in Synthesis Example 2, thereby obtaining binder solutions or dispersion liquids B-13 to B-16 (solid content concentration: 15% by mass) consisting of respective block polymers, except that in Synthesis Example 2, a compound from which each constitutional component is derived was adjusted so that the block polymers B-13 to B-16 had the composition (the kind and the content of the constitutional component) shown in Table 1 and the following chemical formula.

### Synthesis Example 17: Synthesis of Block Polymer BC-1 and Preparation of Binder Dispersion Liquid BC-1

A block polymer BC-1 was synthesized according to “Synthesis Example 5” described in paragraph 0193 of WO2017/030154A.

Using the synthesized block polymer BC-1, a dispersion liquid (solid content concentration: 1% by mass) of the block polymer BC-1 was prepared in the same manner as in the method described in [Synthesis Example 5] of WO2017/030154A.

### Synthesis Examples 18 and 19: Synthesis of Block Polymer BC-2 and BC-3 and Preparation of Binder Solutions BC-2 and BC-3

According to Example 1 described in paragraphs 0101 and 0102 of 2011-054439A, block polymers BC-2 and BC-3 were synthesized by using a compound from which each constitutional component was derived so that the composition (the kind and the content of the constitutional component) shown in Table 1 and the following chemical formula was obtained.

Since the block polymers BC-2 and BC-3 synthesized in this manner were soluble in the dispersion liquid used in the preparation of the dispersion liquid of Synthesis Example 1, they were used as the solutions BC-2 and BC-3 (solid content concentration: 15% by mass) of the respective block polymers.

### Synthesis Examples 20 to 23: Synthesis of Block Polymers BC-4 to BC-6 and BC-8, and Preparation of Binder Dispersion Liquids or Solutions BC-4 to BC-6 and BC-8

Block polymers BC-4 to BC-6 and BC-8 were synthesized in the same manner as in Synthesis Example 1, thereby obtaining binder solutions or dispersion liquids BC-4 to BC-6 and BC-8 (solid content concentration: 50% by mass) consisting of respective block polymers, except that in Synthesis Example 1, a compound from which each constitutional component is derived was adjusted so that the block polymers BC-4 to BC-6 and BC-8 had the composition (the kind and the content of the constitutional component) shown in Table 1 and the following chemical formula.

It is noted that in the block polymers BC-4 and BC-5, the block chains containing two kinds of constitutional components are all block chains consisting of random copolymers of compounds from which the respective constitutional components are derived.

Since the block polymer BC-4 was soluble in the dispersion liquid used in the preparation of the dispersion liquid of Synthesis Example 1, it was used as the solution BC-4 (solid content concentration: 15% by mass). Further, since the block polymer BC-5 was precipitated (without being dispersed in the dispersion medium) in the preparation of the dispersion liquid of Synthesis Example 1, no further evaluation was carried out.

### Synthesis Example 24: Synthesis of Random Polymer BC-7 and Preparation of Binder Dispersion Liquid BC-7

A random polymer BC-7 was synthesized using the same method as that of Synthesis Example 2, except that in Synthesis Example 2, a compound from which each constitutional component is derived was used instead of the block polymerized chain B-4B so that the monomer composition to be dropwise added was to have the composition (the kind and content of the constitutional component) shown in Table 1 and the following chemical formula.

However, since the random polymer BC-7 sedimented, no further evaluation was carried out.

Each of the synthesized block polymers is shown below, together with the C Log P value of each block chain. The number at the lower right of each constitutional component indicates the content (% by mole). It is noted that although the block polymerized chains of the block polymers B-4 and B-13 to B-16 are mainly shown, the main chains of these polymers are constituted of an ethylenically unsaturated bond-derived carbon chain of the (meth)acrylic acid ester compound in the portion surrounded by the broken line.

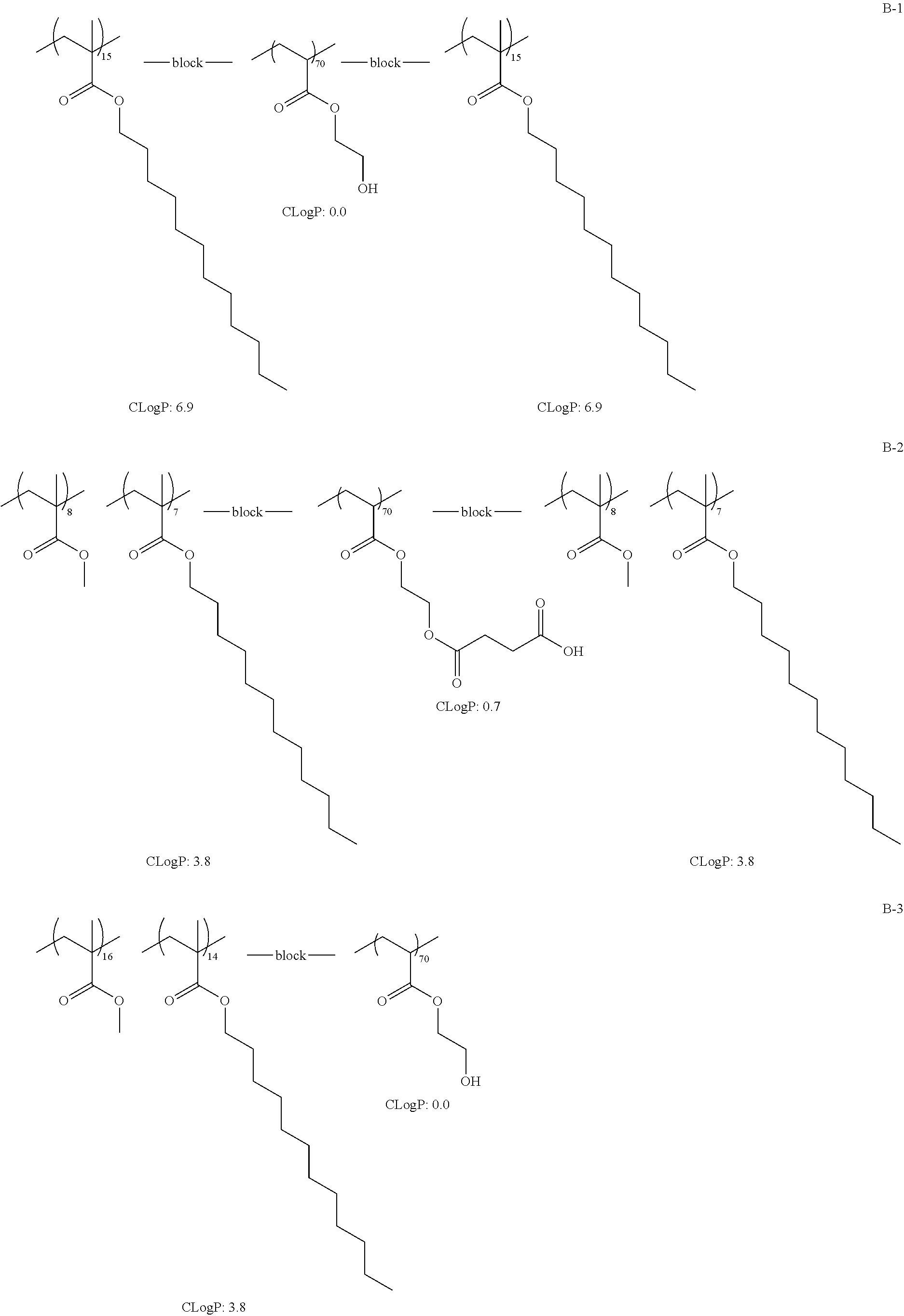

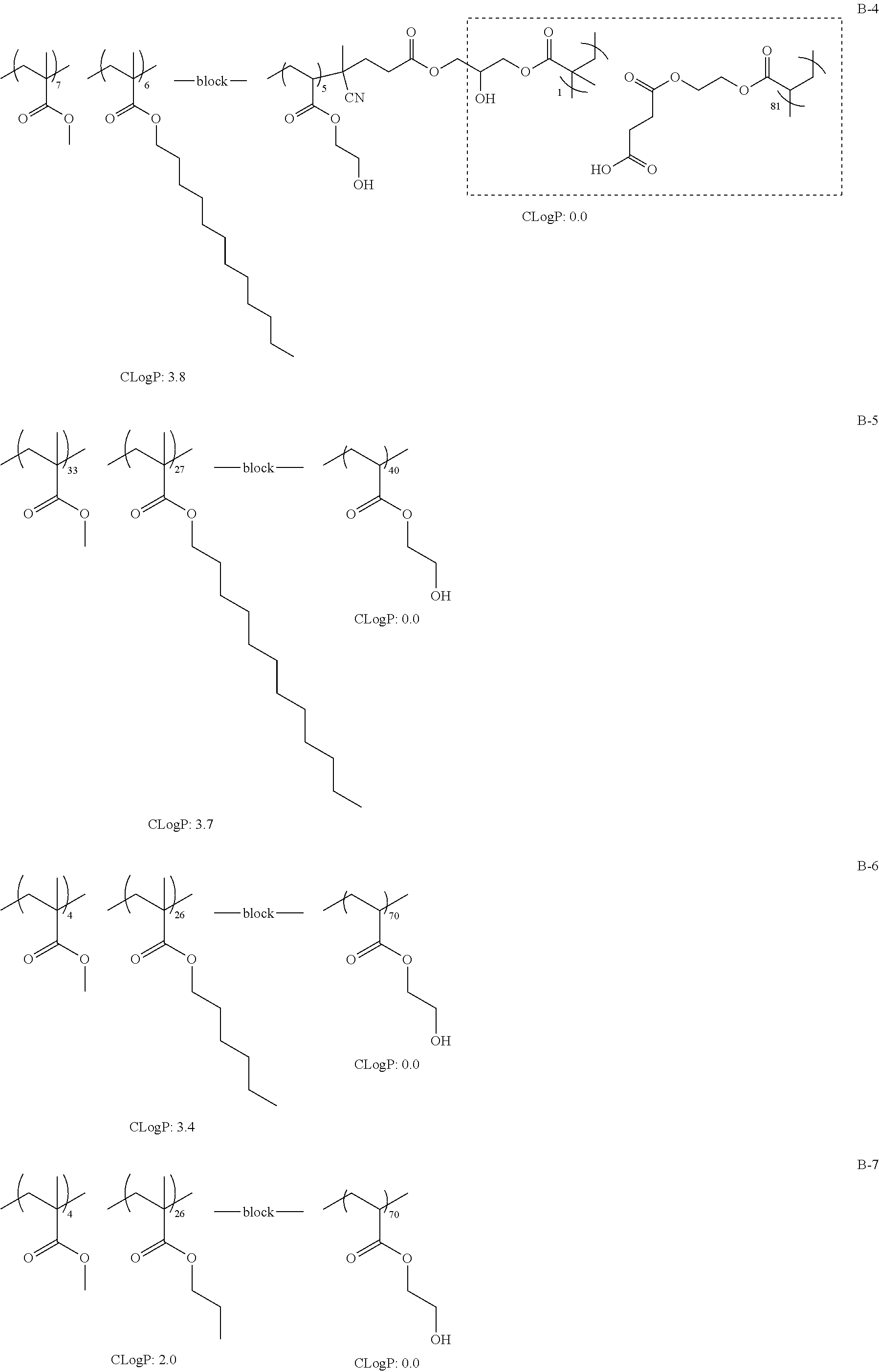

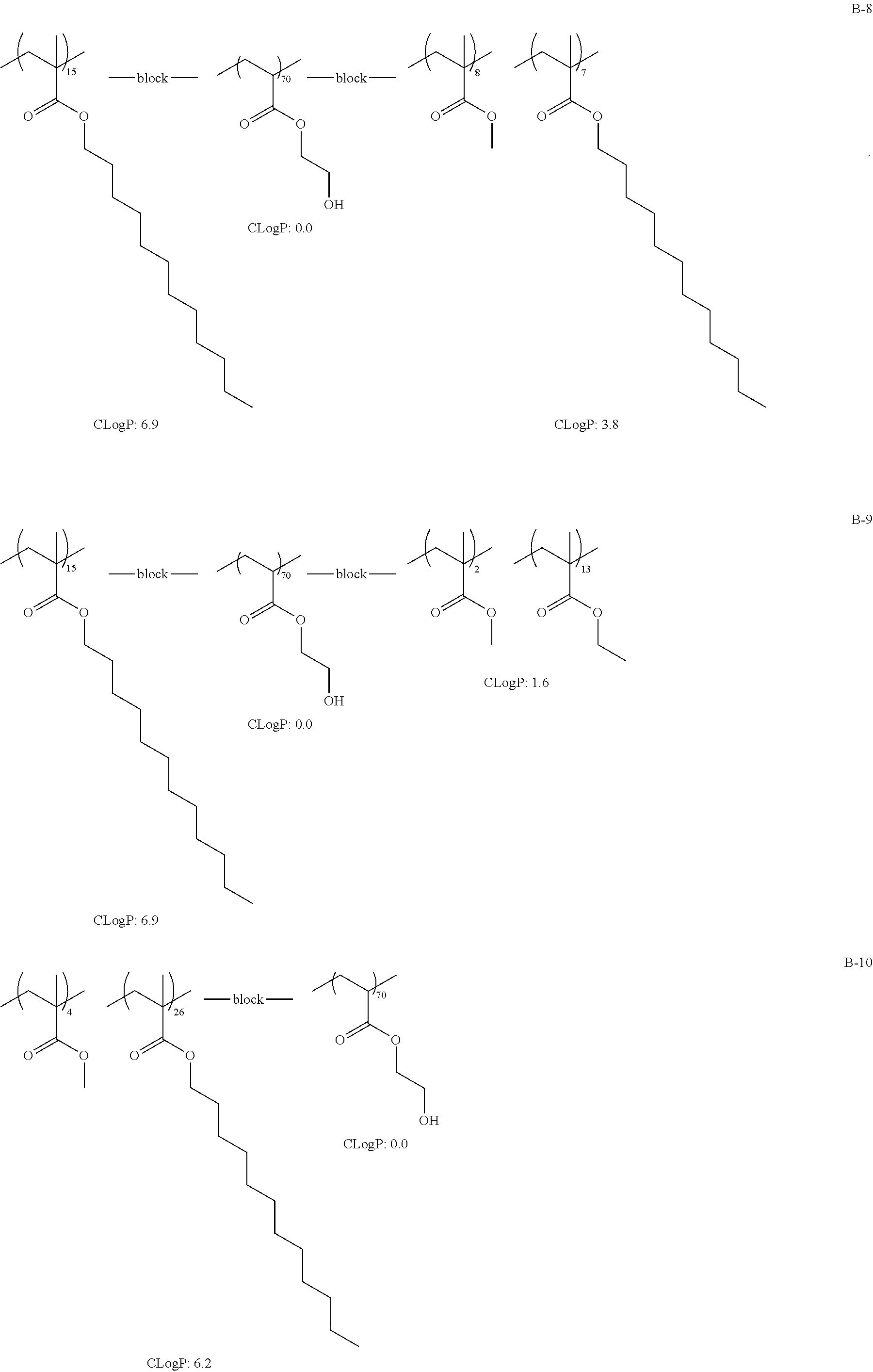

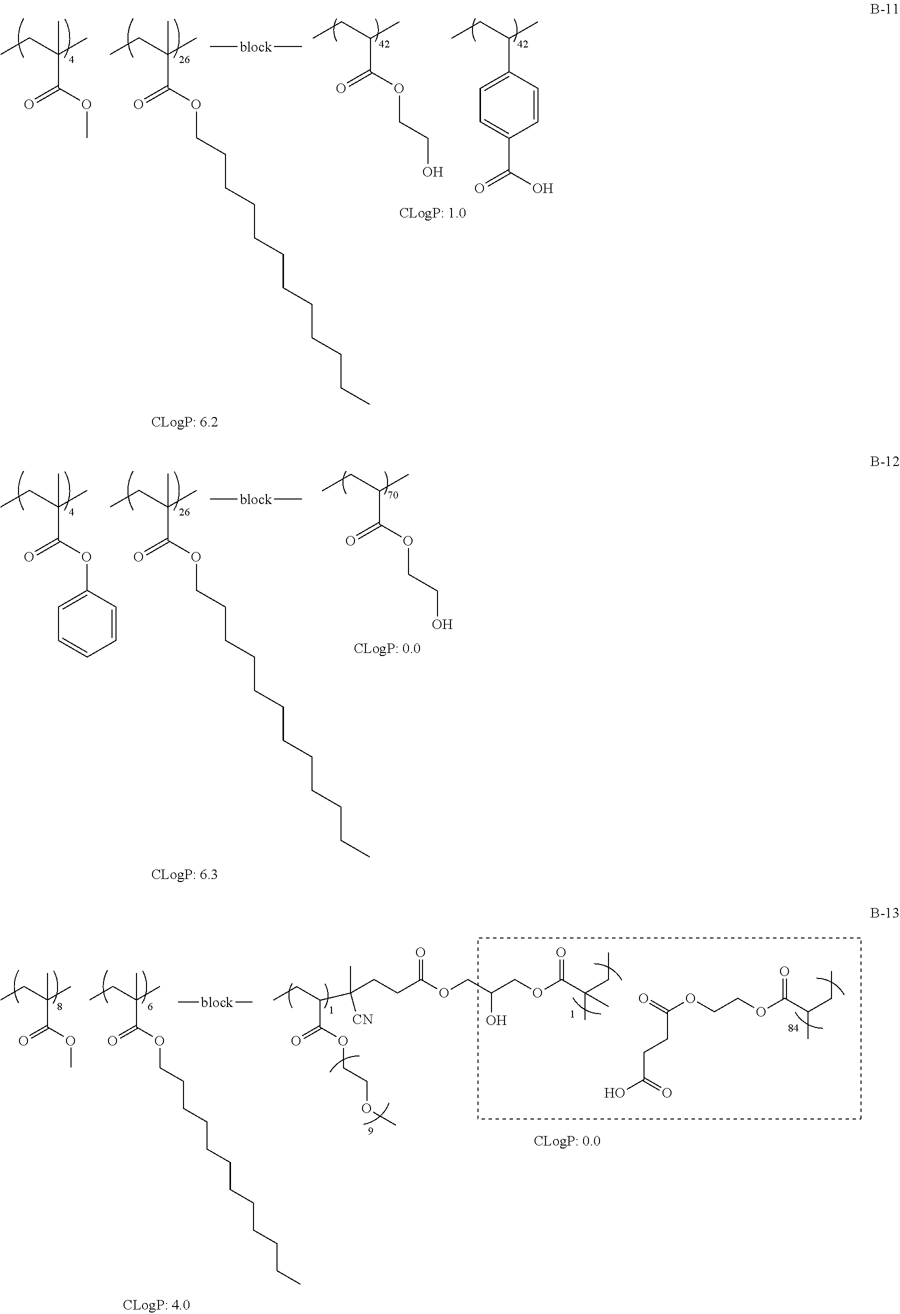

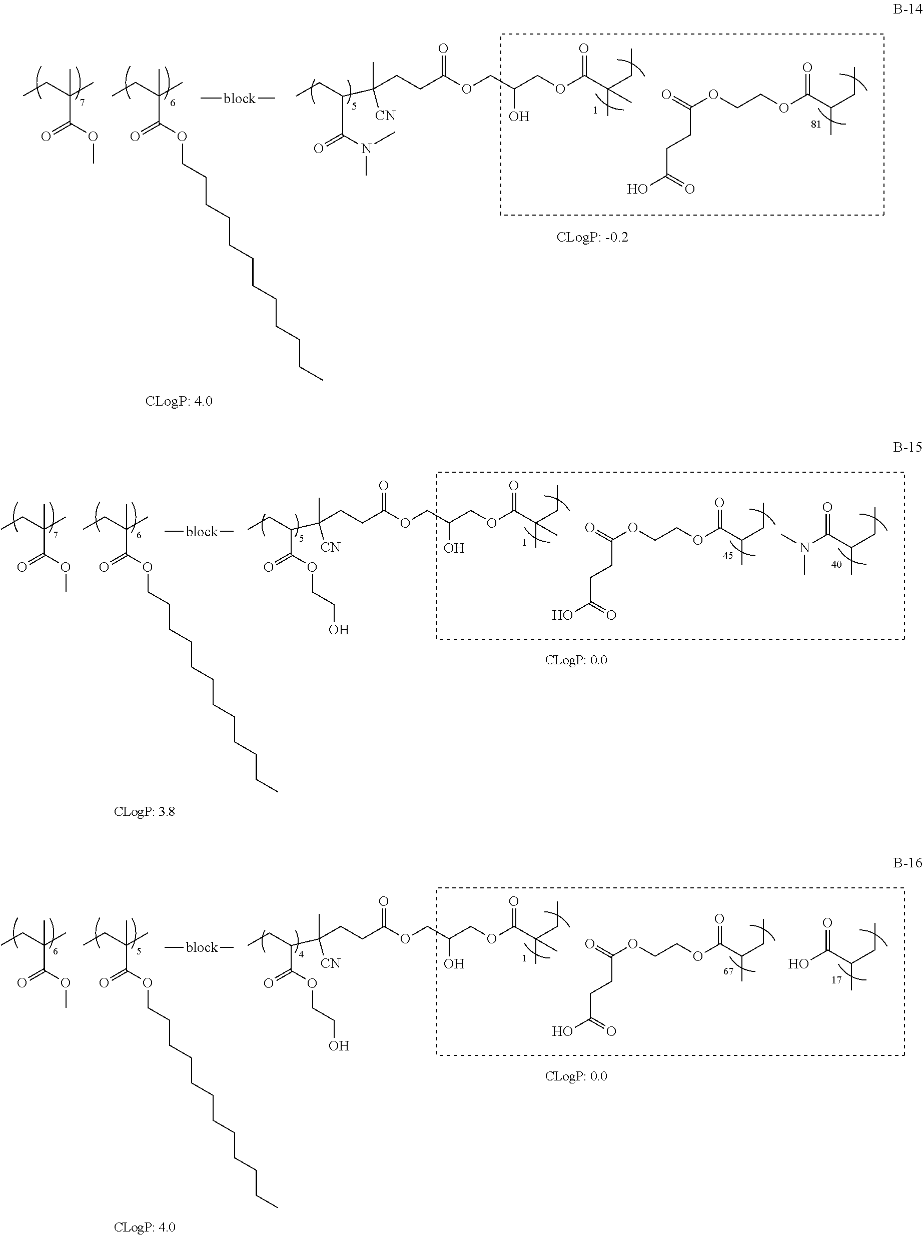

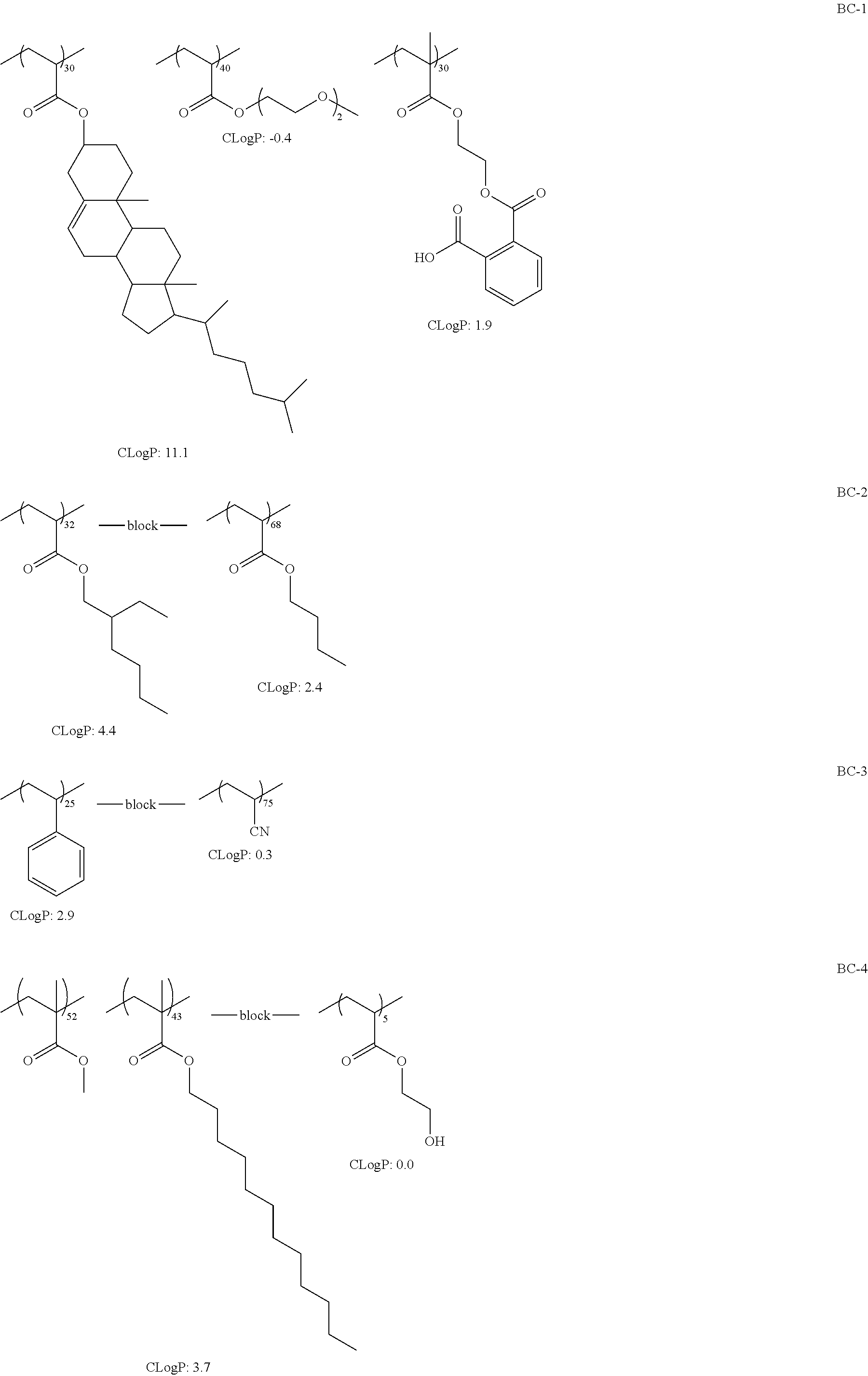

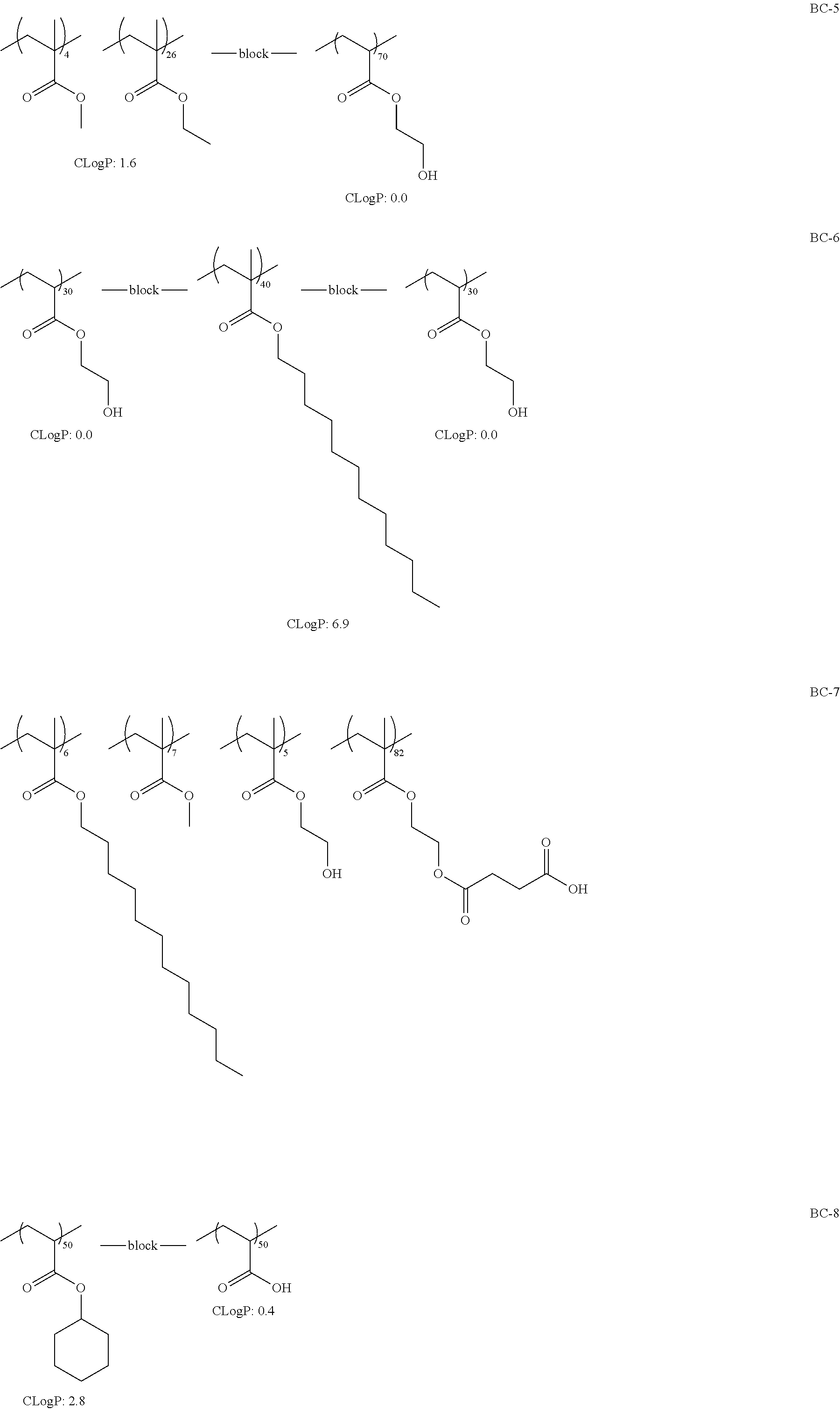

Table 1 shows the composition, the mass average molecular weight, and the average particle diameter of each of the synthesized block polymers, as well as the C Log P value of each block chain. The mass average molecular weight and the average particle diameter of the block polymer and the C Log P value of each block chain were measured by the above methods.

In Table 1, a block chain having a C Log P value of 2 or more is denoted as “Block chain A”, a block chain having a C Log P value of 1 or less is denoted as “Block chain B”, and constitutional components that form a main chain, such as the block polymer B-4 is denoted as “Random copolymerization component”. It is noted that even in a case where the block chains such as the block polymers BC-1 and BC-3 do not correspond to the terminal block or the polar block specified in the present invention, they are described in each column of “Block chain” for convenience.

In Table 1, the difference in C Log P indicates [C Log P value of block chain A1 or A2−C Log P value of block chain B1 or B2], and in a case where the C Log P values of block chains A1 and A2 are different from each other, the difference in the calculated C Log P value is written together by using “/”.

TABLE 1

| | Block chain A1 | | | | | Block chain A2 | | | | | | |
|---|---|---|---|---|---|---|---|---|---|---|---|---|
| | | Constitutional | | Constitutional | | | Constitutional | | | Constitutional | | |
| | | component A1-1 | | component A1-2 | | | component A2-1 | | | component A2-2 | | |
| Block | | | Content | | Content | | | | Content | | Content | |
| polymer | | | (% by | | (% by | | | | (% by | | (% by | |
| No. | CLogP | | mole) | | mole) | | | | mole) | | mole) | |
| BC-1 | 11.1 | Cholesteryl | 30 | — | — | 1.9 | CB-12 | | 30 | — | — | |
| | | acrylate | | | | | | | | | | |
| BC-2 | 4.4 | 2EHA | 32 | — | — | 2.4 | BA | | 68 | — | — | |
| BC-3 | 2.9 | ST | 25 | — | — | — | — | | — | — | — | |
| B-1 | 6.9 | LMA | 15 | — | — | 6.9 | LMA | | 15 | — | — | |
| B-2 | 3.8 | LMA | 7 | MMA | 8 | 3.8 | LMA | | 7 | MMA | 8 | |
| B-3 | 3.8 | LMA | 14 | MMA | 16 | — | — | | — | — | — | |
| B-4 | 3.8 | LMA | 6 | MMA | 7 | — | — | | — | — | — | |
| B-5 | 3.7 | LMA | 27 | MMA | 33 | — | — | | — | — | — | |
| BC-4 | 3.7 | LMA | 43 | MMA | 52 | — | — | | — | — | — | |
| B-6 | 3.4 | HexMA | 26 | MMA | 4 | — | — | | — | — | — | |
| B-7 | 2.0 | PrMA | 26 | MMA | 4 | — | — | | — | — | — | |
| BC-5 | 1.6 | EMA | 26 | MMA | 4 | — | — | | — | — | — | |
| BC-6 | 6.9 | LMA | 40 | — | — | — | — | | — | — | — | |
| B-8 | 6.9 | LMA | 15 | — | — | 3.8 | LMA | | 7 | MMA | 8 | |
| B-9 | 6.9 | LMA | 15 | — | — | 1.6 | EMA | | 13 | MMA | 2 | |
| BC-7 | 3.8 | LMA | 6 | MMA | 7 | — | — | | — | — | — | |
| B-10 | 6.2 | LMA | 26 | MMA | 4 | — | — | | — | — | — | |
| B-11 | 6.2 | LMA | 26 | MMA | 4 | — | — | | — | — | — | |
| BC-8 | 2.8 | CHA | 50 | — | — | — | — | | — | — | — | |
| B-12 | 6.3 | LMA | 26 | PhMA | 4 | — | — | | — | — | — | |
| B-13 | 3.8 | LMA | 6 | MMA | 8 | — | — | | — | — | — | |
| B-14 | 3.8 | LMA | 6 | MMA | 7 | — | — | | — | — | — | |
| B-15 | 3.8 | LMA | 4 | MMA | 6 | — | — | | — | — | — | |
| B-16 | 3.8 | LMA | 5 | MMA | 6 | — | — | | — | — | — | |
| | Block chain B1 | | | | | | | | | | | |
| | | | Constitutional | | | | | | Constitutional | | | |
| | | | component | | | | | | component | | | |
| Block | | | B1-1 | | | | | | B1-2 | | | |
| polymer | | | | | | Content | | | | Content | | |
| No. | | | | | | (% by mole) | | | | (% by mole) | | |
| BC-1 | −0.4 | | PEG | | | 40 | | | — | — | | |
| BC-2 | — | | — | | | — | | | — | — | | |
| BC-3 | 0.3 | | AN | | | 75 | | | — | — | | |
| B-1 | 0.0 | | HEA | | | 70 | | | — | — | | |
| B-2 | 0.7 | | AEHS | | | 70 | | | — | — | | |
| B-3 | 0.0 | | HEA | | | 70 | | | — | — | | |
| B-4 | 0.0 | | HEA | | | 5 | | | — | — | | |
| B-5 | 0.0 | | HEA | | | 40 | | | — | — | | |
| BC-4 | 0.0 | | HEA | | | 5 | | | — | — | | |
| B-6 | 0.0 | | HEA | | | 70 | | | — | — | | |
| B-7 | 0.0 | | HEA | | | 70 | | | — | — | | |
| BC-5 | 0.0 | | HEA | | | 70 | | | — | — | | |
| BC-6 | 0.0 | | HEA | | | 30 | | | — | — | | |
| B-8 | 0.0 | | HEA | | | 70 | | | — | — | | |
| B-9 | 0.0 | | HEA | | | 70 | | | — | — | | |
| BC-7 | 0.0 | | HEA | | | 5 | | | — | — | | |
| B-10 | 0.0 | | HEA | | | 70 | | | — | — | | |
| B-11 | 1.0 | | HEA | | | 42 | | | ST-A | 28 | | |
| BC-8 | 0.4 | | AA | | | 50 | | | — | — | | |
| B-12 | 0.0 | | HEA | | | 70 | | | — | — | | |
| B-13 | −0.7 | | AME400 | | | 1 | | | — | — | | |
| B-14 | −0.2 | | DMAAm | | | 5 | | | — | — | | |
| B-15 | 0.0 | | HEA | | | 4 | | | — | — | | |
| B-16 | 0.0 | | HEA | | | 4 | | | — | — | | |
| | Block chain B2 | | | Random copoloymerization component | | | | | | | | |
| | | Constitutional | | Constitutional | | | Constitutional | | | Constitutional | | |
| | | component B2 | | component 1 | | | component 2 | | | component 3 | | |
| Block | | | Content | | | Content | | | Content | | | Content |
| polymer | | | (% by | | | (% by | | | (% by | | | (% by |
| No | CLogP | | mole) | CLogP | | mole) | CLogP | | mole) | CLogP | | mole) |
| BC-1 | — | — | — | — | — | — | — | — | — | — | — | — |
| BC-2 | — | — | — | — | — | — | — | — | — | — | — | — |
| BC-3 | — | — | — | — | — | — | — | — | — | — | — | — |
| B-1 | — | — | — | — | — | — | — | — | — | — | — | — |
| B-2 | — | — | — | — | — | — | — | — | — | — | — | — |
| B-3 | — | — | — | — | — | — | — | — | — | — | — | — |
| B-4 | — | — | — | 0.7 | AEHS | 81 | 0.7 | GMA | 1 | — | — | — |
| B-5 | — | — | — | — | — | — | — | — | — | — | — | — |
| BC-4 | — | — | — | — | — | — | — | — | — | — | — | — |
| B-6 | — | — | — | — | — | — | — | — | — | — | — | — |
| B-7 | — | — | — | — | — | — | — | — | — | — | — | — |
| BC-5 | — | — | — | — | — | — | — | — | — | — | — | — |
| BC-6 | 0.0 | HEA | 30 | — | — | — | — | — | — | — | — | — |
| B-8 | — | — | — | — | — | — | — | — | — | — | — | — |
| B-9 | — | — | — | — | — | — | — | — | — | — | — | — |
| BC-7 | — | — | — | 0.7 | AEHS | 82 | — | — | — | — | — | — |
| B-10 | — | — | — | — | — | — | — | — | — | — | — | — |
| B-11 | — | — | — | — | — | — | — | — | — | — | — | — |
| BC-8 | — | — | — | — | — | — | — | — | — | — | — | — |
| B-12 | — | — | — | — | — | — | — | — | — | — | — | — |
| B-13 | — | — | — | 0.7 | AEHS | 84 | 0.7 | GMA | 1 | — | — | — |
| B-14 | — | — | — | 0.7 | AEHS | 81 | 0.7 | GMA | 1 | — | — | — |
| B-15 | — | — | — | 0.7 | AEHS | 45 | −0.2 | DMAAm | 40 | 0.7 | GMA | 1 |
| B-16 | — | — | — | 0.7 | AEHS | 67 | 0.7 | MAA | 17 | 0.7 | GMA | 1 |

| | Mass | Average | | |
|---|---|---|---|---|
| Block | average | particle | | |
| polymer | molecular | diameter | Difference | |
| No | weight | (nm) | in CLogP | Note |
| BC-1 | 8600 | 50 | 11.5/2.3 | Comparative |
| | | | | Example |
| BC-2 | 3000 | Solution | — | Comparative |
| | | | | Example |
| BC-3 | 50000 | Solution | 2.6 | Comparative |
| | | | | Example |
| B-1 | 7100 | 80 | 6.9 | Present invention |
| B-2 | 6500 | 90 | 3.1 | Present invention |
| B-3 | 6800 | 100 | 3.8 | Present invention |
| B-4 | 504000 | 110 | 3.8 | Present invention |
| B-5 | 8500 | 50 | 3.7 | Present invention |
| BC-4 | 11000 | Sedimented | 3.7 | Comparative |
| | | | | Example |
| B-6 | 6000 | 100 | 3.4 | Present invention |
| B-7 | 5800 | 250 | 2.0 | Present invention |
| BC-5 | 5400 | Sedimented | 1.6 | Comparative |
| | | | | Example |
| BC-6 | 7100 | 250 | 6.9 | Comparative |
| | | | | Example |
| B-8 | 6700 | 90 | 6.9/3.8 | Present invention |
| B-9 | 6100 | 140 | 6.9/1.6 | Present invention |
| BC-7 | 482000 | | 3.8 | Comparative |
| | | | | Example |
| B-10 | 6800 | 90 | 6.2 | Presen tinvention |
| B-11 | 7200 | 130 | 5.2 | Present invention |
| BC-8 | 7400 | 280 | 2.4 | Comparative |
| | | | | Example |
| B-12 | 7000 | 90 | 6.3 | Present invention |
| B-13 | 554000 | 250 | 4.5 | Present invention |
| B-14 | 453000 | 220 | 4.0 | Present invention |
| B-15 | 605000 | 160 | 3.8 | Present invention |
| B-16 | 550000 | 200 | 3.8 | Present invention |

<Abbreviations in Table>
In the table, “—” in the column of the constitutional component indicates that the constitutional component does not have a corresponding constitutional component.
Cholesteryl acrylate (synthesized according to Journal of Organic Chemistry, 2008, vol. 73, # 12, p. 4476-4483)
CB-12: 2-methacryloyloxyethyl phthalic acid (CB-12: product name, manufactured by Shin-Nakamura Chemical Co., Ltd.)
PEG: Polyethylene glycol monomethyl ether acrylate (number average molecular weight: 850, manufactured by Tokyo Chemical Industry Co., Ltd.)
2EHA: 2-ethylhexyl acrylate, manufactured by Tokyo Chemical Industry Co., Ltd.)
BA: n-butyl acrylate (manufactured by Tokyo Chemical Industry Co., Ltd.)
ST: Styrene (manufactured by FUJIFILM Wako Pure Chemical Corporation)
AN: Acrylonitrile (manufactured by Tokyo Chemical Industry Co., Ltd.)
LMA: Dodecyl methacrylate (manufactured by FUJIFILM Wako Pure Chemical Corporation)
HEA: 2-Hydroxyethyl acrylate (manufactured by FUJIFILM Wako Pure Chemical Corporation)
MMA: Methyl methacrylate (manufactured by FUJIFILM Wako Pure Chemical Corporation, CLogP value: 1.1)
AEHS: Mono(2-acryloyloxyethyl) succinate (manufactured by Tokyo Chemical Industry Co., Ltd.)
HexMA: n-hexyl methacrylate (manufactured by Tokyo Chemical Industry Co., Ltd., CLogP value: 3.8)
PrMA: n-propyl methacrylate (manufactured by FUJIFILM Wako Pure Chemical Corporation, CLogP value: 2.2)
EMA: Ethyl methacrylate (manufactured by Tokyo Chemical Industry Co., Ltd., SP value: 1.6)
CHA: Cyclohexyl acrylate (Tokyo Chemical Industry Co., Ltd., CLogP value: 2.8)
PhMA: Phenyl methacrylate (Tokyo Chemical Industry Co., Ltd., CLogP value: 2.3)
ST-A: 4-vinylbenzoic acid (Tokyo Chemical Industry Co., Ltd., CLogP value: 2.6)
AA: Acrylic acid (manufactured by FUJIFILM Wako Pure Chemical Corporation, CLogP value: 0.4)
GMA: Glycidyl methacrylate (manufactured by FUJIFILM Wako Pure Chemical Corporation, CLogP value: 0.7)
AME400: Blemmer AME400 (manufactured by NOF Corporation, CLogP value: −0.7)
DMAAm: N,N′-dimethylacrylamide (manufactured by FUJIFILM Wako Pure Chemical Corporation, CLogP value: −0.2)
MAA: Methacrylic acid (manufactured by FUJIFILM Wako Pure Chemical Corporation, CLogP value: 0.7)

2. Synthesis of Sulfide-Based Inorganic Solid Electrolyte

### Synthesis Example A

A sulfide-based inorganic solid electrolyte was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box under an argon atmosphere (dew point: −70° C.), lithium sulfide (Li₂S, manufactured by Sigma-Aldrich Co., LLC Co., LLC, purity: >99.98%) (2.42 g) and diphosphorus pentasulfide (P₂S₅, manufactured by Sigma-Aldrich Co., LLC Co., LLC, purity: >99%) (3.90 g) each were weighed, put into an agate mortar, and mixed using an agate muddler for 5 minutes. The mixing ratio between Li₂S and P₂S₅(Li₂S:P₂S₅) was set to 75:25 in terms of molar ratio.

Next, 66 zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining a yellow powder (6.20 g) of a sulfide-based inorganic solid electrolyte (Li—P—S-based glass, hereinafter, may be denoted as LPS). The average particle diameter of the Li—P—S-based glass was 2.5 μm.

### Example 1

Using each of the prepared binders, an inorganic solid electrolyte-containing composition and a positive electrode composition were prepared to produce an all-solid state secondary battery.

<Preparation of Inorganic Solid Electrolyte-Containing Composition>

180 zirconia beads having a diameter of 5 mm was put into a 45 mL container made of zirconia (manufactured by FRITSCH), and 4.85 g of LPS synthesized in the above Synthesis Example A or Li_{0.33}La_{0.55}TiO₃ (LLT), 0.15 g (solid content mass) of the binder dispersion liquid or the like shown in Table 2 below, and 11.0 g of butyl butyrate were put thereinto. Then, this container was set in a planetary ball mill P-7 (product name) manufactured by FRITSCH. Mixing was carried out at a temperature of 25° C. and a rotation speed of 150 rpm for 10 minutes, thereby preparing each of inorganic solid electrolyte-containing compositions C-1 to C-17 and BC-1 to BC-8 (however, as described above, the compositions BC-5 and BC-7, using the block polymer BC-5 or BC-7, are omitted, the same applies hereinafter).

Table 2 shows the difference in the C Log P value between the dispersion medium and the terminal block chain of the block copolymerized chain in each block polymer [the C Log P value of the terminal block chain−the C Log P value of the dispersion medium] (in terms of absolute value). In a case where there are a plurality of C Log P values, they are written together by using “/”.

TABLE 2

| | | | Binder dispersion liquid | | | | |
|---|---|---|---|---|---|---|---|
| Inorganic solid | Inorganic solid electrolyte | | or the like | | | | Sheet for all-solid state |
| electrolyte-containing | | Content | | Content | Dispersion | Difference in | secondary battery |
| composition No. | Kind | (% by mole) | Kind | (% by mole) | medium | CLogP | No. |
| C-1 | LPS | 97 | B-1 | 3 | Butyl butyrate | 4.1 | S-1 |
| C-2 | LPS | 97 | B-2 | 3 | Butyl butyrate | 1.0 | S-2 |
| C-3 | LPS | 97 | B-3 | 3 | Butyl butyrate | 1.0 | S-3 |
| C-4 | LPS | 97 | B-4 | 3 | Butyl butyrate | 1.0 | S-4 |
| C-5 | LPS | 97 | B-5 | 3 | Butyl butyrate | 0.9 | S-5 |
| C-6 | LPS | 97 | B-6 | 3 | Butyl butyrate | 0.6 | S-6 |
| C-7 | LPS | 97 | B-7 | 3 | Butyl butyrate | 0.8 | S-7 |
| BC-1 | LPS | 97 | BC-1 | 3 | Butyl butyrate | 8.3/0.9 | BS-1 |
| BC-2 | LPS | 97 | BC-2 | 3 | Butyl butyrate | 1.6/0.4 | BS-2 |
| BC-3 | LPS | 97 | BC-3 | 3 | Butyl butyrate | 0.1 | BS-3 |
| BC-4 | LPS | 97 | BC-4 | 3 | Butyl butyrate | 0.9 | BS-4 |
| BC-6 | LPS | 97 | BC-6 | 3 | Butyl butyrate | 2.8 | BS-6 |
| C-8 | LPS | 97 | B-8 | 3 | Butyl butyrate | 4.1/1.0 | S-8 |
| C-9 | LPS | 97 | B-9 | 3 | Butyl butyrate | 4.1 | S-9 |
| C-10 | LPS | 97 | B-10 | 3 | Butyl butyrate | 3.4 | S-10 |
| C-11 | LPS | 97 | B-11 | 3 | Butyl butyrate | 3.4 | S-11 |
| BC-8 | LPS | 97 | BC-8 | 3 | Butyl butyrate | 0.0 | BS-8 |
| C-12 | LPS | 97 | B-12 | 3 | Butyl butyrate | 3.5 | S-12 |
| C-13 | LLT | 97 | B-12 | 3 | Butyl butyrate | 3.5 | S-13 |
| C-14 | LPS | 97 | B-13 | 3 | Butyl butyrate | 4.5 | S-14 |
| C-15 | LPS | 97 | B-14 | 3 | Butyl butyrate | 4.0 | S-15 |
| C-16 | LPS | 97 | B-15 | 3 | Butyl butyrate | 3.8 | S-16 |
| C-17 | LPS | 97 | B-16 | 3 | Butyl butyrate | 3.8 | S-17 |

<Production of Solid Electrolyte Sheet for all-Solid State Secondary Battery>

For each inorganic solid electrolyte-containing composition, a composition after preparation (before being left to stand for 24 hours) and a composition after being left to stand for 24 hours (the upper half of the total amount of the composition after being left to stand) after preparation (temperature: 25° C., relative humidity: in an environment of less than 0.1%, 6 mL of each composition was put into a cylindrical container having a bottom area of 1.5 cm²) were used to produce a solid electrolyte sheet for an all-solid state secondary battery as a set of two sheets.

Using a baker-type applicator (product name: SA-201, manufactured by Tester Sangyo Co., Ltd.), each inorganic solid electrolyte-containing composition was applied on an aluminum foil having a thickness of 20 μm, and heating was carried out at 80° C. for 2 hours to dry (remove the dispersion medium) the inorganic solid electrolyte-containing composition. Then, using a heat press machine, the dried inorganic solid electrolyte-containing composition was pressurized at a temperature of 120° C. and a pressure of 600 MPa for 10 seconds to produce each of solid electrolyte sheets S-1 to 5-17 and BS-1 to BS-8 for an all-solid state secondary battery. The film thickness of the solid electrolyte layer was 50 μm.

<Preparation of Positive Electrode Composition>

180 zirconia beads having a diameter of 5 mm was put into a 45 mL container made of zirconia (manufactured by FRITSCH), and 2.7 g of LPS synthesized in the above Synthesis Example A, 0.3 g (solid content mass) of the binder dispersion liquid or the like shown in Table 3, and 22 g of butyl butyrate were put thereinto. The container was set in a planetary ball mill P-7 (product name, manufactured by FRITSCH) and the constitutional components were mixed for 60 minutes at a temperature of 25° C. and a rotation speed of 300 rpm. Then, 7.0 g of LiNi_{1/3}Co_{1/3}Mn_{1/3}O₂ (NMC) or LiNi_{0.8}5Co_{0.10}Al_{0.05}O₂ (NCA) was put into a container as the positive electrode active material. Similarly, the container was set in a planetary ball mill P-7 (product name), mixing was continued at a temperature of 25° C. and a rotation speed of 100 rpm for 5 minutes. In this manner, each of positive electrode compositions U-1 to U-17 and V-1 to V-8 were prepared.

In each positive electrode composition, the difference in the C Log P value between the dispersion medium and the terminal block chain of the block copolymerized chain in each block polymer [the C Log P value of the terminal block chain−the C Log P value of the dispersion medium] (in terms of absolute value) is the same as that of the inorganic solid electrolyte-containing composition using the same block polymer (Table 2), the description thereof in Table 3 is omitted.

TABLE 3

| | | | | | | | | Positive |
|---|---|---|---|---|---|---|---|---|
| | | | | | | | | electrode |
| | | | | | | | | sheet for |
| Composition | Positive electrode | | Inorganic solid | | Binder dispersion | | | all-solid state |
| for positive | active material | | electrolyte | | liquid or the like | | | secondary |
| electrode | | Content | | Content | | Content | Dispersion | battery |
| No. | Kind | (% by mole) | Kind | (% by mole) | Kind | (% by mole) | medium | No. |
| U-1 | NMC | 70 | LPS | 27 | B-1 | 3 | Butyl | PU-1 |
| | | | | | | | butyrate | |
| U-2 | NMC | 70 | LPS | 27 | B-2 | 3 | Butyl | PU-2 |
| | | | | | | | butyrate | |
| U-3 | NMC | 70 | LPS | 27 | B-3 | 3 | Butyl | PU-3 |
| | | | | | | | butyrate | |
| U-4 | NMC | 70 | LPS | 27 | B-4 | 3 | Butyl | PU-4 |
| | | | | | | | butyrate | |
| U-5 | NMC | 70 | LPS | 27 | B-5 | 3 | Butyl | PU-5 |
| | | | | | | | butyrate | |
| U-6 | NMC | 70 | LPS | 27 | B-6 | 3 | Butyl | PU-6 |
| | | | | | | | butyrate | |
| U-7 | NMC | 70 | LPS | 27 | B-7 | 3 | Butyl | PU-7 |
| | | | | | | | butyrate | |
| V-1 | NMC | 70 | LPS | 27 | BC-1 | 3 | Butyl | PV-1 |
| | | | | | | | butyrate | |
| V-2 | NMC | 70 | LPS | 27 | BC-2 | 3 | Butyl | PV-2 |
| | | | | | | | butyrate | |
| V-3 | NMC | 70 | LPS | 27 | BC-3 | 3 | Butyl | PV-3 |
| | | | | | | | butyrate | |
| V-4 | NMC | 70 | LPS | 27 | BC-4 | 3 | Butyl | PV-4 |
| | | | | | | | butyrate | |
| V-6 | NMC | 70 | LPS | 27 | BC-6 | 3 | Butyl | PV-6 |
| | | | | | | | butyrate | |
| U-8 | NMC | 70 | LPS | 27 | B-8 | 3 | Butyl | PU-8 |
| | | | | | | | butyrate | |
| U-9 | NMC | 70 | LPS | 27 | B-9 | 3 | Butyl | PU-9 |
| | | | | | | | butyrate | |
| U-10 | NMC | 70 | LPS | 27 | B-10 | 3 | Butyl | PU-10 |
| | | | | | | | butyrate | |
| U-11 | NMC | 70 | LPS | 27 | B-11 | 3 | Butyl | PU-11 |
| | | | | | | | butyrate | |
| V-8 | NMC | 70 | LPS | 27 | BC-8 | 3 | Butyl | PV-8 |
| | | | | | | | butyrate | |
| U-12 | NMC | 70 | LPS | 27 | B-12 | 3 | Butyl | PU-12 |
| | | | | | | | butyrate | |
| U-13 | NCA | 70 | LPS | 27 | B-12 | 3 | Butyl | PU-13 |
| | | | | | | | butyrate | |
| U-14 | NMC | 70 | LPS | 27 | B-13 | 3 | Butyl | PU-14 |
| | | | | | | | butyrate | |
| U-15 | NMC | 70 | LPS | 27 | B-14 | 3 | Butyl | PU-15 |
| | | | | | | | butyrate | |
| U-16 | NMC | 70 | LPS | 27 | B-15 | 3 | Butyl | PU-16 |
| | | | | | | | butyrate | |
| U-17 | NMC | 70 | LPS | 27 | B-16 | 3 | Butyl | PU-17 |
| | | | | | | | butyrate | |

<Production of Positive Electrode Sheet for all-Solid State Secondary Battery>

For each positive electrode composition, a composition after preparation (before being left to stand for 24 hours) and a composition after being left to stand for 24 hours (the upper half of the total amount of the composition after being left to stand) after preparation (temperature: 25° C., relative humidity: in an environment of less than 0.1%, 6 mL of each composition was put into a cylindrical container having a bottom area of 1.5 cm²) were used to produce a positive electrode sheet for an all-solid state secondary battery as a set of two sheets.

Using a baker-type applicator (product name: SA-201), the prepared positive electrode composition was applied on an aluminum foil having a thickness of 20 μm, and heating was carried out at 80° C. for 2 hours to dry (remove the dispersion medium) the positive electrode composition. Then, using a heat press machine, the dried positive electrode composition was pressurized at 25° C. (10 MPa, 1 minute) to produce each of positive electrode sheets PU-1 to PU-17 and PV-1 to PV-8 for an all-solid state secondary battery including a positive electrode active material layer having a film thickness of 80 μm.

<Preparation of Negative Electrode Composition>

180 zirconia beads having a diameter of 5 mm was put into a 45 mL container made of zirconia (manufactured by FRITSCH), and, 4.0 g of LPS synthesized in Synthesis Example A, and 0.3 g of KYNAR FLEX 2500-20 (product name) as a solid content mass, and 12.0 g of butyl butyrate were put thereinto. The container was set in a planetary ball mill P-7 (product name, manufactured by FRITSCH) and the constitutional components were mixed for 60 minutes at a temperature of 25° C. and a rotation speed of 300 rpm. Then, 5.3 g of silicon (Si, manufactured by Sigma-Aldrich Co., LLC) or graphite (CGB, manufactured by Nippon Graphite Industries, Co., Ltd.) as the negative electrode active material, and 0.4 g of acetylene black (manufactured by Denka Company Limited) as the conductive auxiliary agent were put into a container. Similarly, the container was set in a planetary ball mill P-7, and mixing was carried out at a temperature of 25° C. for 10 minutes at a rotation speed of 100 rpm to prepare a negative electrode composition (a slurry).

<Production of Negative Electrode Sheet for all-Solid State Secondary Battery>

Using a baker-type applicator (product name: SA-201), the prepared negative electrode composition was applied on a copper foil having a thickness of 20 μm, and heating was carried out at 80° C. for 2 hours to dry (remove the dispersion medium) the negative electrode composition. Then, using a heat press machine, the dried negative electrode composition was pressurized (10 MPa, 1 minute) at 25° C. to produce a negative electrode sheet for an all-solid state secondary battery, having a negative electrode active material layer having a film thickness of 80 μm.

<Production of Negative Electrode Sheet for all-Solid State Secondary Battery, which has Solid Electrolyte Layer>

Next, each of the produced solid electrolyte sheets S-1 to S-17 and BS-1 to BS-8 for an all-solid state secondary battery was overlaid on the negative electrode active material layer of the prepared negative electrode sheet so that the solid electrolyte layer came in contact the negative electrode active material layer, and pressurized using a press machine at a temperature of 25° C. and a pressurizing force of 50 MPa, and transferred (laminated). The obtained laminate was further pressurized at a temperature of 25° C. and a pressurizing force of 600 MPa to produce a negative electrode sheet for an all-solid state secondary battery having a solid electrolyte layer. In each sheet, the film thickness of the solid electrolyte layer was 50 μm, and the film thickness of the negative electrode active material layer was 75 μm.

The negative electrode sheet for an all-solid state secondary battery having a solid electrolyte layer is specified by the number of the used solid electrolyte sheet for an all-solid state secondary battery for convenience. For example, the negative electrode sheet for an all-solid state secondary battery having a solid electrolyte layer, produced by using the solid electrolyte sheet S-1 for an all-solid state secondary battery is referred to as S-1.

<Manufacturing of all-Solid State Secondary Battery>

For the inorganic solid electrolyte-containing composition and the positive electrode composition, both compositions after preparation (before being left to stand for 24 hours) and both compositions after being left to stand for 24 hours after preparation were respectively used to produce respective sheets, which were subsequently used to manufacture all-solid state secondary batteries.

That is, a disk-shaped negative electrode sheet having a diameter of 14.5 mm was cut out from each negative electrode sheet for an all-solid state secondary battery having a solid electrolyte layer, produced by using the respective compositions before and after standing, and individually put into a 2032-type coin case 11 made of stainless steel, equipped with a spacer and a washer (not illustrated in FIG. 2). Next, the positive electrode sheet for an all-solid state secondary battery (the positive electrode active material layer and the aluminum foil had been peeled off in advance) punched out into a diameter of 14.0 mm was overlaid on the solid electrolyte layer (the aluminum foil had been peeled off in advance) of this disk-shaped negative electrode sheet. Here, for the negative electrode sheet for an all-solid state secondary battery having the solid electrolyte layer produced by using the inorganic solid electrolyte-containing composition before standing, the positive electrode sheet for an all-solid state secondary battery produced by using the positive electrode composition before standing in the combination of the layer constitution shown in Table 4 was overlaid. Similarly, for the negative electrode sheet for an all-solid state secondary battery having the solid electrolyte layer produced by using the inorganic solid electrolyte-containing composition after standing, the positive electrode sheet for an all-solid state secondary battery produced by using the positive electrode composition after standing in the combination of the layer constitution shown in Table 4 was overlaid. Next, a stainless steel foil (a positive electrode collector) was further overlaid on the positive electrode active material layer to form a laminate 12 for an all-solid state secondary battery (a laminate consisting of copper foil-negative electrode active material layer-solid electrolyte layer-positive electrode active material layer-stainless steel foil). Then, the 2032-type coin case 11 was crimped to manufacture each of coin-type all-solid state secondary batteries No. 101 to 119 and c11 to c18 (however, c15 and c17 are omitted) illustrated in FIG. 2. In this manner, as the all-solid state secondary battery having each No., a set of two batteries of an all-solid state secondary battery manufactured by using both compositions before preparation and an all-solid state secondary battery prepared using both compositions after standing was obtained.

<Evaluation of Battery Resistance>

As the battery performance of the all-solid state secondary battery No. 101 to 119 and c11 to c18, the battery resistance of each set of the batteries manufactured by using the compositions before and after being left to stand for 24 hours, for the inorganic solid electrolyte-containing composition and the positive electrode composition, was measured, and the rate of change in battery resistance was evaluated.

The resistance of each of the all-solid state secondary batteries was evaluated using a charging and discharging evaluation device “TOSCAT-3000” (product name, manufactured by Toyo System Corporation). Specifically, each of the all-solid state secondary batteries was charged at a current density of 0.1 mA/cm² until the battery voltage reached 4.2 V. Then, the battery was discharged at a current density of 0.2 mA/cm² until the battery voltage reached 2.5 V. These one time of charging and one time of discharging were set as one cycle, and two cycles of charging and discharging were repeated. After carrying out discharging at 5 mAh/g (amount of electricity per 1 g of the mass of the active material) of the second cycle, the battery voltage was read.

In one set of the all-solid state secondary batteries represented by the same battery No., the rate of change in battery voltage ([resistance value of all-solid state secondary battery manufactured using compositions after being left to stand for 24 hours/resistance value of all-solid state secondary battery manufactured using compositions before being left to stand for 24 hours]×100(%)) was determined, and the resistance change rate of the all-solid state secondary battery was evaluated according to which of the following evaluation ranks include this change rate as the resistance change rate.

In the test, the higher the evaluation rank, the higher the dispersion stability of the composition, and it is possible to suppress the deterioration of battery performance (an increase in battery resistance) due to the reaggregation and sedimentation of solid particles in the composition. The passing level of this test is the evaluation rank of “3” or more.

It is noted that the resistance value of the battery manufactured by using the compositions before being left to stand for 24 hours was small enough to sufficiently meet the high level of demands of recent years as an all-solid state secondary battery.

—Evaluation Rank—

8: 100%≤resistance change rate <101%

7: 101%≤resistance change rate <105%

6: 105%≤resistance change rate <108%

5: 108%≤resistance change rate <110%

4: 110%≤resistance change rate <115%

3: 115%≤resistance change rate <118%

2: 118%≤resistance change rate <120%

1: 120%≤resistance change rate

TABLE 4

| | Layer constitution | | | | |
|---|---|---|---|---|---|
| | | Solid | | | |
| All-solid | Positive | electrolyte | | | |
| state | electrode | layer | Negative | | |
| secondary | active | (Negative | electrode | Resistance | |
| battery | material | electrode | active | change | |
| No. | layer | sheet) | material | rate | Note |
| 101 | PU-1 | S-1 | Silicon | 6 | Present invention |
| 102 | PU-2 | S-2 | Silicon | 7 | Present invention |
| 103 | PU-3 | S-3 | Silicon | 8 | Present invention |
| 104 | PU-4 | S-4 | Silicon | 8 | Present invention |
| 105 | PU-S | S-5 | Silicon | 7 | Present invention |
| 106 | PU-6 | S-6 | Silicon | 5 | Present invention |
| 107 | PU-7 | S-7 | Silicon | 4 | Present invention |
| c11 | PV-1 | BS-1 | Silicon | 2 | Comparative Example |
| c12 | PV-2 | BS-2 | Silicon | 1 | Comparative Example |
| c13 | PV-3 | BS-3 | Silicon | 2 | Comparative Example |
| c14 | PV-4 | BS-4 | Silicon | 2 | Comparative Example |
| c16 | PV-6 | BS-6 | Silicon | 2 | Comparative Example |
| 108 | PU-8 | S-8 | Silicon | 7 | Present invention |
| 109 | PU-9 | S-9 | Silicon | 5 | Present invention |
| 110 | PU-10 | S-10 | Silicon | 8 | Present invention |
| 111 | PU-11 | S-11 | Silicon | 7 | Present invention |
| c18 | PV-8 | BS-8 | Silicon | 1 | Comparative Example |
| 112 | PU-12 | S-12 | Silicon | 8 | Present invention |
| 113 | PU-4 | S-13 | Silicon | 7 | Present invention |
| 114 | PU-13 | S-4 | Silicon | 8 | Present invention |
| 115 | PU-4 | S-4 | Graphite | 8 | Present invention |
| 116 | PU-14 | S-14 | Silicon | 3 | Present invention |
| 117 | PU-15 | S-15 | Silicon | 8 | Present invention |
| 118 | PU-16 | S-16 | Silicon | 8 | Present invention |
| 119 | PU-17 | S-17 | Silicon | 8 | Present invention |

### Example 2

An all-solid state secondary battery was manufactured in the same manner as in Example 1, except that in Example 1, a composition after 24 hours after preparation was used for only one of the inorganic solid electrolyte-containing composition and the positive electrode composition, and the battery resistance thereof was evaluated.

As a result of the evaluation, in the all-solid state secondary batteries using the inorganic solid electrolyte-containing composition after being left to stand for 24 hours after preparation, and the all-solid state secondary battery using the positive electrode composition after being left to stand for 24 hours after preparation, the same results (tendency) as those of the all-solid state secondary battery (Example 1) using the inorganic solid electrolyte-containing composition and the positive electrode composition after being left to stand for 24 hours after preparation were obtained.

### Example 3

An all-solid state secondary battery in which all of the positive electrode active material layer, the solid electrolyte layer, and the negative electrode active material layer contained binder particles B-4 consisting of the block polymer B-4 was manufactured in the same manner as in the all-solid state secondary battery No. 104 of Example 1, except that in the all-solid state secondary battery No. 104 of Example 1, the binder particles (the binder dispersion liquid B-4) consisting of the block polymer B-4 were used instead of KYNAR FLEX 2500-20 (product name) as the binder of the negative electrode composition. As a result of evaluating the battery resistance of this all-solid state secondary battery in the same manner as in Example 1, the evaluation rank of the resistance change rate was “^{8”}.

The following can be seen from the results of Example 1 (Table 4) to Example 3.

All of the all-solid state secondary batteries No. c11 to c18 of Comparative Examples include a solid electrolyte layer and a positive electrode active material layer, formed by using a composition (an inorganic solid electrolyte-containing composition and a positive electrode composition) that do not contain the binder particles specified in the present invention, and the rise in battery voltage is large. It is conceived that this is because the dispersion stability of the composition is not sufficient and the increase in the interfacial resistance between the solid particles in the solid electrolyte layer and the positive electrode active material layer cannot be sufficiently suppressed. In particular, the block polymers BC-5 and BC-7 could not form binder particles with which the battery performance would be evaluated in a case of being used in the inorganic solid electrolyte-containing composition.

On the other hand, all of the all-solid state secondary batteries No. 101 to 119 of Examples of the present invention include a solid electrolyte layer and a positive electrode active material layer, formed by using compositions (an inorganic solid electrolyte-containing composition and a positive electrode composition) that contain the binder particles specified in the present invention, and the rise in battery voltage is small. The is presumed to be because the compositions used have high dispersion stability, the temporal reaggregation or precipitation of solid particles (for example, after 24 hours) can be suppressed, and as a result, an increase in interfacial resistance between solid particles can be effectively suppressed even in the solid electrolyte layer and the positive electrode active material layer.

It can be seen that this effect can be exhibited even in a case where the binder particles specified in the present invention are used only in one of the compositions of the inorganic solid electrolyte-containing composition and the positive electrode composition as in Example 2. Further, even in a case where a negative electrode active material (silicon), which has a large expansion and contraction due to charging and discharging and accelerates the deterioration of battery performance, is used as the negative electrode active material, the deterioration of battery performance can be effectively suppressed.

The present invention has been described together with the embodiments of the present invention. However, the inventors of the present invention do not intend to limit the present invention in any part of the details of the description unless otherwise specified, and it is conceived that the present invention should be broadly construed without departing from the spirit and scope of the invention shown in the attached “WHAT IS CLAIMED IS”.

This application claims priority based on JP2019-197783 filed in Japan on Oct. 30, 2019, which is incorporated herein by reference as a part of the description of the present specification.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
11: 2032-type coin case
12: laminate for all-solid state secondary battery
13: coin-type all-solid state secondary battery

What is claimed is:

1. An inorganic solid electrolyte-containing composition comprising:
an inorganic solid electrolyte having an ion conductivity of a metal belonging to Group 1 or Group 2 in the periodic table;
binder particles having an average particle diameter of 10 nm or more and 1,000 nm or less; and
a dispersion medium,
wherein a block polymer is contained to constitute the binder particles, and
the block polymer contains a block polymerized chain which has at least one terminal block chain having a C Log P value of 2 or more and having a constitutional component represented by Formula (1) and has a block chain having a C Log P value of 1 or less, the block chain being adjacent to the terminal block chain, 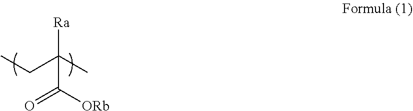
in Formula (1), Ra represents a hydrogen atom, a hydroxy group, a cyano group, a halogen atom, or an alkyl group having 1 to 6 carbon atoms, and
Rb represents a linear or branched alkyl group having 3 or more carbon atoms.

2. The inorganic solid electrolyte-containing composition according to claim 1,
wherein the terminal block chain contains at least two constitutional components.

3. The inorganic solid electrolyte-containing composition according to claim 1,
wherein the block polymer is represented by Formula (2),
A-B Formula (2)
in Formula (2), A represents the terminal block chain, and B represents the block chain having a C Log P value of 1 or less.

4. The inorganic solid electrolyte-containing composition according to claim 1,
wherein the block polymer is represented by Formula (3), 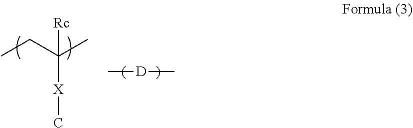
in Formula (3), Re represents a hydrogen atom, a hydroxy group, a cyano group, a halogen atom, or an alkyl group having 1 to 6 carbon atoms, and X represents a divalent linking group, C represents the block polymerized chain, and D represents a constitutional component having a C Log P value of 1 or less.

5. The inorganic solid electrolyte-containing composition according to claim 4,
wherein X is an alkylene group having 1 to 6 carbon atoms, an oxygen atom, a cyano group, a carbonyl group, or a group obtained by combining these, and is a linking group having 1 to 35 constituent atoms.

6. The inorganic solid electrolyte-containing composition according to claim 3,
wherein in the block polymerized chain, a content of the terminal block chain is 35% by mole or less, and a content of the block chain having a C Log P value of 1 or less is 65% by mole or more.

7. The inorganic solid electrolyte-containing composition according to claim 1,
wherein the binder particles have an average particle diameter of 50 to 250 nm.

8. The inorganic solid electrolyte-containing composition according to claim 1,
wherein an alkyl group adoptable as Rb has 8 or more carbon atoms.

9. The inorganic solid electrolyte-containing composition according to claim 1,
wherein the terminal block chain has a C Log P value of 3.5 or more.

10. The inorganic solid electrolyte-containing composition according to claim 1,
wherein a C log P value of the block chain having a C log P value of 1 or less is 0.7 or less.

11. The inorganic solid electrolyte-containing composition according to claim 1,
wherein the block chain having a C Log P value of 1 or less contains a constitutional component derived from a (meth)acrylic acid or a (meth)acrylic acid ester compound.

12. The inorganic solid electrolyte-containing composition according to claim 1,
wherein the block chain having a C Log P value of 1 or less has a functional group selected from the following group G of functional groups,
<the group G of functional groups>
a hydroxy group, a mercapto group, a carboxy group, a phosphate group, an amino group, a cyano group, an isocyanate group, an amide group, a urea group, a urethane group, an imide group, an isocyanurate group.

13. The inorganic solid electrolyte-containing composition according to claim 1, further comprising an active material.

14. The inorganic solid electrolyte-containing composition according to claim 1, further comprising a conductive auxiliary agent.

15. The inorganic solid electrolyte-containing composition according to claim 1,
wherein the inorganic solid electrolyte is a sulfide-based inorganic solid electrolyte.

16. A sheet for an all-solid state secondary battery, comprising a layer constituted of the inorganic solid electrolyte-containing composition according to claim 1.

17. An all-solid state secondary battery comprising, in the following order:
a positive electrode active material layer;
a solid electrolyte layer; and
a negative electrode active material layer,
wherein at least one layer of the positive electrode active material layer, the solid electrolyte layer, or the negative electrode active material layer is a layer constituted of the inorganic solid electrolyte-containing composition according to claim 1.

18. A manufacturing method for a sheet for an all-solid state secondary battery, the manufacturing method comprising forming a film of the inorganic solid electrolyte-containing composition according to claim 1.

19. A manufacturing method for an all-solid state secondary battery, the manufacturing method comprising manufacturing an all-solid state secondary battery through the manufacturing method according to claim 18.
